(19) United States
(12) Patent Application Publication
(10) Pub. No.: US 2016/0214557 A1
(43) Pub. Date: Jul. 28, 2016

(54) ANTI-ROLLOVER DEVICE FOR VEHICLES

(71) Applicant: Pasquale VILLA, Carpaneto Piacentino (PC) (IT)

(72) Inventor: Pasquale VILLA, Carpaneto Piacentino (PC) (IT)

(21) Appl. No.: 14/914,984

(22) PCT Filed: Aug. 28, 2014
(86) PCT No.: PCT/IB2014/064134

§ 371 Date: Feb. 26, 2016

(30) Foreign Application Priority Data
Aug. 28, 2013 (IT) PI2013A000076

(51) Int. Cl. B60R 21/13; B60R 21/0132; B62D 49/08

(52) U.S. Cl. CPC B60R 21/13; B62D 49/08; B60R 21/0132; B60R 2021/0273

(57) ABSTRACT

An anti-rollover device for a vehicle includes at least two safety legs, each arranged at respective sides of the vehicle, and having a free end portion and an opposite end portion constrained to the vehicle, through which the safety legs are connected to the vehicle movably between a rest position and a support safety position in order to stop a lateral rollover of the vehicle. The device also includes an actuator for moving each leg from the rest position to the support safety position; a sensor for measuring a quantity related to an early rollover condition of the vehicle, the sensor configured for producing a measurement signal; an automatic controller for receiving the measurement signal and for sending the control signal to the actuator, so that in case of a rollover condition at least one of the legs moves from the rest position to the support safety position.

### FIELD OF THE INVENTION

The present invention relates to a safety device to prevent the rollover of vehicles with at least three wheels, in particular of narrow vehicles and/or of high-barycentre vehicles and/or of vehicles without suspension.

In particular, the device is useful for such vehicles as lift trucks, and for other vehicles normally, but not necessarily, equipped with a cabin and with a roll-bar type protection, small digging machines, and the like.

### BACKGROUND OF THE INVENTION

### Technical Problem

Lift trucks are normally used to displace loads such as packed goods or mechanical parts within industrial sheds, yards, factories and the like. These vehicles are normally equipped with a cabin and with a protection, known as roll cage, that are intended for improving the safety of a driver within the cabin, in the case of an accident, or if a heavy object falls on the cabin, or also if the truck turns over.

When travelling on an uneven ground, lift trucks carrying a load may become particularly unstable and are likely to turn over, since these vehicles are normally narrow, with respect to their length, and since they are usually not provided with a suspension, in order to be more stable when lifting a load. An overturning while travelling can be caused by any unevenness of the ground such as a pothole, as well as road bumps, road drains, which are frequently found in industrial areas, and with which the wheels of the lift truck are likely to come into contact while the vehicle is travelling.

An overturning may also occur if the vehicle turns at a relatively high speed, considering the radius of the turning made by the lift truck. The risk of an overturning is therefore higher if the carried load is in a raised position, for instance, when setting down or when loading objects on/from shelves, for stacking pallets and containers, and so on.

When an overturning occurs, the driver is likely to instinctively try to leave the cabin in order to save himself. The driver is often projected out from the cabin during an initial stage of the capsizing, and falls to the ground. In this case, the forklift may in turn fall upon the driver and hurt him/her seriously or even bring him/her to death, typically by head injury. In most lethal accidents, the driver is crushed by the uprights of the cabin or by the heavy structure of the roll cage protection. Therefore, even if the roll cage is conceived to protect the driver when he/she is in the cabin, it paradoxically turns into a serious hazard, if an overturning occurs and if the driver is projected out of the cabin itself.

This problem could be solved by a box-shaped cabin structure, i.e. a structure with four closed sides. However, this solution cannot be accepted since it reduces the visibility, it is not user-friendly and creates an unfavourable microclimate inside the cabin.

Therefore, the need is felt of a device to protect a driver of a vehicle, in particular of a narrow vehicle and/or of a vehicle in which the weight is mainly concentrated in a high portion of it, and/or of a vehicle without suspension, from the consequences of an overturning of the vehicle, as already described.

Several types of vehicle are known in the art (see WO0156866, NL1014496, WO2010043233, U.S. Pat. No. 6,588,799, DE1297485, DE9016969U1) which are provided with anti-rollover devices. However, these devices comprise actuation systems that cannot ensure safe and reliable operation, in case of an overturning.

### SUMMARY OF THE INVENTION

It is therefore an object of the present invention to provide a device for a vehicle, in particular for a narrow vehicle and/or for a high-barycentre vehicle and/or for a vehicle without suspension, such as a forklift, which protects the driver of the vehicle from the consequences of a rollover of the vehicle.

More in particular, it is an object of the invention to provide such a device that has a small encumbrance, and that does not hamper or disturbs the work of the driver and the normal operation of the vehicle.

It is also a feature of the present invention to provide such a device that is more reliable than the known devices against accidental and unwanted actuation, i.e. in the absence of a rollover condition.

It is also a feature of the present invention to provide a roll-bar type structure, or a roll-bar type cabin, that is equipped with such an anti-rollover device.

These and other objects are achieved by an anti-rollover device for a vehicle having lateral sides, a longitudinal axis and a longitudinal midplane, the anti-rollover device comprising:
at least two safety legs comprising a right safety leg and a left safety leg, each arranged at a respective side of the vehicle,
each of the safety legs having a free end portion and an articulated end portion that is articulated to the vehicle opposite to the free end portion,
wherein each of the safety legs is connected to the vehicle through the articulated end portion,
wherein each of the safety legs is movable between a rest position, with minimum encumbrance with respect to the vehicle, and a support safety position, in which the free end portion is located at a distance from a respective side of the vehicle so as to stop the rollover of the vehicle by one of the safety legs,
an actuator means configured for causing each of the safety legs to move from the rest position to the support safety position;
a sensor means for detecting a value of a quantity related to an early rollover condition of the vehicle, the sensor means configured for producing a measurement signal responsive to said value;
an automatic control unit configured for receiving this signal and for activating the actuator means according to the signal, in such a way that, in the early rollover condition, the actuator means causes at least one of the safety legs to move impulsively from the rest position to the support safety position,
   whose main feature is that the automatic control unit comprises a logical unit configured for carrying out a comparison of such signal with a limit value of the respective quantity, beyond which an early rollover condition of the vehicle occurs, the automatic control unit configured for triggering the actuator means according to this comparison, i.e. when the logical unit assesses this early rollover condition by said comparison.

This way, a safety device is obtained that operates automatically in case the vehicle runs up against an unevenness of the ground such as a pothole and the like, which can cause it to roll over. The device can prevent the vehicle from rollovering and from falling down to the ground, so it prevents the driver, who can be expelled out of the vehicle and/or thrown down to the ground while being expelled, or while trying to escape from the cabin, from being run over by a vehicle such as a lift truck, which often has lethal consequences.

Advantageously, the safety leg is arranged in such a way that said safety distance is longer than 0.5 m, in particular it is longer than 1 m, more in particular, is longer than 1.5 m, even more in particular, it is longer than 2 m.

The articulated end portion can be pivotally connected for carrying out a rotation with respect to the vehicle by a rotatable mutual engagement means about a rotation axis, and
in the rest position, each safety leg is arranged along the respective side of the vehicle with a rest inclination with respect to the longitudinal midplane of the vehicle, and
in the support safety position, each safety leg has a safety inclination with respect to the longitudinal midplane of the vehicle outwards of the vehicle, in such a way that the free end portion is located at the safety distance from the respective side of the vehicle.

Preferably, the rotatable mutual engagement means is configured to be arranged with the rotation axis at an orientation angle with respect to the direction of the longitudinal axis of the vehicle. This way, the support end of the safety leg, besides a lateral movement, carries out a forward movement with respect to the vehicle, in such a way that the support end, in the support safety position, is in contact with the ground at a position closer to the front part of the vehicle, where the load lifting forks are commonly located, with respect to when it is at the rest position. This makes it possible to prevent the vehicle, in the case of a rollover event, from turning about a substantially vertical axis, i.e. from leaning on and pivoting about the safety leg when the latter is in contact with the ground by its own support end. This can happen in case of some masses distributions of the vehicle.

In an exemplary embodiment, the rotatable mutual engagement means is configured to be arranged above a cabin structure of the vehicle. For example, the means for connecting comprises a frame arranged above a cabin structure of the vehicle, the frame comprising right and left connection beams, wherein a guide element for the rotation of each right and left safety leg is connected parallel to the respective right or left connection beam.

In another exemplary embodiment, the rotatable mutual engagement means is configured to be arranged on the respective side of the vehicle, in particular below a cabin structure of the vehicle.

In a further exemplary embodiment, the rotatable mutual engagement means is configured to be arranged at an upper portion of a lifting guide element the vehicle, in particular of a forklift.

Advantageously, each safety leg comprises an upper portion and a lower portion configured for slideably engaging with the upper portion along a common longitudinal direction. This way, it is possible to predetermine more reliably the position, with respect to the vehicle, where the safety leg will come into contact with the ground. In fact, the protrusion of the lower portion, and so the overall length of the safety leg, is a further geometric variable of the configuration of the safety leg.

In particular, the lower portion has a lower end that, in a rest position, is arranged above the wheel housing of the vehicle. This provides a minimum encumbrance configuration, in most vehicles, in which the cabin is more narrow than the wheel housing.

In particular, the upper portion has a longitudinal recess, i.e. it has a hollow cross section, and the lower portion is slideably arranged within the longitudinal recess of the upper portion.

In an exemplary embodiment, the anti-rollover device comprises a slide actuator means or a slide unlock means of the lower portion with respect to the upper portion, and the automatic control unit is configured for operating the slide actuator means or the slide unlock means along with the actuator means of the rotation of the safety legs, so that the free end portion comes into contact with the ground in a predetermined position with respect to the vehicle.

As an alternative, the articulated end portion can be slideably connected to the vehicle through a slidable mutual engagement means. In particular, the slidable mutual engagement means has a slide direction at an operation angle with respect to the longitudinal midplane of the vehicle, outwards of the vehicle. For example, the sliding engagement means can comprise a slide guide arranged on each side of the vehicle and at the operation angle with respect to the vertical of the vehicle, in particular a guide with a hollow cross section in which the safety leg engages.

The actuator means of the rotation of the safety leg with respect to the vehicle can comprise any suitable conventional actuator means.

For instance, the actuator means can be a hydraulic actuator means. A hydraulic actuator means has the advantage, for some vehicles, of being fed by an on-board hydraulic circuit, for example the hydraulic circuit that makes it possible to operate the lifting means the lift trucks.

As an alternative, the actuator means can be a pneumatic actuator means. The pneumatic actuator means has the advantage, for some vehicles, to be fed by an on-board compressor.

As an alternative, the actuator means can be an electromechanical actuator means.

As an alternative, the actuator means can be a mechanical actuator comprising an actuation spring, and the anti-rollover device comprises a removable lock means for locking the safety legs at the rest position, wherein the actuation spring is arranged to be kept stretched or compressed when a respective safety leg is at the rest position, and to recall the respective safety leg from the rest position to the support safety position, when the removable lock means are removed. The mechanical spring actuation means has a manual reset means, by which the spring is manually pre-compressed or pre-stretched, or a reset means controlled by an actuator.

In particular the sensor means of a quantity related to an early rollover condition of the vehicle comprises an accelerometer configured for measuring lateral acceleration components of the vehicle, and for producing an electric lateral acceleration signal responsive to said acceleration components.

As an alternative, or in addition, the sensor means of a quantity related to an early rollover condition of the vehicle can comprise a gyroscopic sensor configured for measuring an orientation of the vehicle, and configured for producing an electric space orientation signal of the vehicle.

As an alternative, or in addition, the sensor means of a quantity related to an early rollover condition of the vehicle can comprises an inclinometer configured for measuring a lateral inclination of the vehicle, i.e. an inclination in a transversal direction with respect to the longitudinal axis of the vehicle, which is a direction of a possible rollover movement the vehicle, and configured for producing an electric lateral inclination signal of the vehicle responsive to said lateral inclination.

In an exemplary embodiment, the logical unit comprises:
a data input means, in particular an input means of a control panel, for inputting data of:
   weight and volume of the vehicle;
   weight and volume of a load arranged on board of the vehicle;
a computing means for computing the position of the barycentre, in particular the distance from a longitudinal midplane of the vehicle, of a group comprising the vehicle and the load arranged on the vehicle, starting from the weight and volume data of the vehicle and/or of the load;
   and the logical unit is configured for combining the position of the barycentre and the electric lateral acceleration signal before carrying out the comparison of the intensity of the signals with the limit values of the respective physical quantities. In particular the input means comprises an input means for inputting elevation data of the load with respect to a reference plane, in order to calculate the position of the barycentre. In particular the means for computing the barycentre is configured for determining a distance of the barycentre from the longitudinal midplane of the vehicle.

Advantageously, the means for computing the barycentre comprises a data acquisition unit configured for receiving weight data and/or volume data of the load, and the means for computing the barycentre comprises a computing means for computing the position of the barycentre, starting from data acquired from the unit for acquisition. Preferably, the data acquisition unit is configured for receiving also current elevation data of the load. In a forklift, these elevation data can comprise the elevation of the forks. This way, the operation of the anti-rollover device can based on a reliable mass distribution condition, which is particularly useful in the case of a load that is in raised position while being carried. Moreover, the data acquisition unit can be configured for receiving weight data and/or volume data of the vehicle and/or weight data and/or volume data of the driver. As an alternative, the automatic control unit can comprise a memory unit configured for receiving, for example as preliminary factory or installation settings, predetermined weight and/or volume data of the vehicle and/or the driver, in order to limit the number of current settings to be given when using the vehicle.

Advantageously, the automatic control unit is configured for receiving the position of the barycentre as calculated by the means for computing the barycentre, and the automatic control unit comprises a means for combining the position of the barycentre with the measurement signal generated by the sensor means. This improves the reliability of the device of the device, since the safety legs are actuated with reference to a reliable distribution of the masses of the vehicle, of the load and of the driver.

Advantageously, the automatic control unit is configured for receiving an auxiliary signal, and to emit the control signal only if the auxiliary signal exceeds a predetermined threshold value. This makes accidental operation of the safety legs less likely to occur, as in the case of fault of one of the driving sensors, in particular if an inclinometer, used as a driving sensor, receives an impulsive action.

The device can comprise an auxiliary sensor, or an interface suitable for communicating with an auxiliary sensor, configured for measuring a quantity related to a ground contact condition or to a ground no-contact condition of at least one wheel of the vehicle. In particular, the automatic control unit, for example the logical unit thereof, is configured for combining a plurality of auxiliary signals, in order to determine whether a side of the vehicle is raised from the ground or not, and for generating a permission signal to allow the emission of the control signal only if one side of the vehicle is found to be raised with respect to the ground.

In an exemplary embodiment, the auxiliary sensor comprises a distance sensor arranged for measuring a distance of a portion of the vehicle from the ground, in particular the distance of the bottom of the vehicle from the ground. For example, the distance sensor can comprise an electromagnetic sensor, such as a radar sensor or an optical sensor. As an alternative, or in addition, the distance sensor can comprise an acoustic sensor, such as an ultrasonic sensor. As an alternative, or in addition, the distance sensor can comprise a mechanical tasting device configured to engage with the ground. As an alternative, or in addition, the auxiliary sensor comprises a force sensor arranged for measuring the weight borne by each wheel of the vehicle. In these cases, the automatic control unit is configured for comparing the auxiliary signal with a threshold value. In particular, the automatic control unit is configured for detecting a sudden change of the weight borne by a plurality of wheels, for example by a couple of right or left wheels, in a vehicle having an even number of wheels, for example four wheels, and is also configured to generate a permission signal to allow the emission of the control signal in case of change in a same direction only on a right or on a left plurality of wheels.

It falls within the scope of the invention also a protection apparatus comprising a passive roll-bar type protection structure and as well as a protection device as described above, to be mounted to vehicles having with at least three wheels, in particular to narrow vehicles and/or to high-barycentre vehicles and/or to vehicles without suspension, which are likely to overturn, that are not equipped with a roll-bar protection.

### BRIEF DESCRIPTION OF THE DRAWINGS

The invention will be now shown with the description of an exemplary embodiment thereof, exemplifying but not limitative, with reference to the attached drawings in which:

FIG. 1 is a diagrammatical front or rear view of a vehicle and of an anti-rollover device according to an aspect of the invention;

FIG. 2 is a perspective front view of a forklift having an anti-rollover device according to a first exemplary embodiment of the invention, in which the safety legs of the device are shown in its rest position;

FIGS. 3 and 4 are front and lateral perspective views of the forklift of FIG. 2, in a condition in which an overturning has been avoided thanks to the device according to the invention;

FIGS. 5, 6 and 7 are perspective views of a detail of the anti-rollover device according to the first exemplary embodiment of the invention that is provided with a hydraulic or a pneumatic or a electromechanical or a selectively compressed spring mechanical actuation device, respectively;

FIG. 8 is a perspective front view of a forklift provided with an anti-rollover device according to a second exemplary embodiment of the invention, wherein one of the safety legs is shown in its rest position;

FIG. 9 is a perspective rear view of the forklift of FIG. 8, in which an overturning has been avoided thanks to the device according to the invention;

FIG. 10 is a perspective front view of a forklift having an anti-rollover device according to a third exemplary embodiment of the invention, wherein a sliding safety leg is shown in its rest position;

FIG. 11 shows a perspective view of the actuator means for a safety leg of the anti-rollover device FIG. 10, with a safety leg of the device shown in its rest position;

FIG. 12 shows a perspective view of the anti-rollover device FIGS. 10 and 11, with one of the safety legs of the device shown in its support safety position;

FIG. 13 is a view of a detail of the safety leg of FIG. 12;

FIG. 14 is a diagrammatical front or rear view of a vehicle and of an anti-rollover device according to another aspect of the invention;

FIG. 15 is a perspective view of a forklift provided with an anti-rollover device according to a fourth exemplary embodiment of the invention, wherein one of the safety legs is in its support safety position and the other is in its rest position;

FIG. 16 is a side view of the forklift of FIG. 15, in which an overturning has been avoided thanks to the device according to the invention;

FIGS. 17 and 18 are longitudinal sectional views of a safety leg of the anti-rollover device according to the invention, in which an actuator means of the lower portion is a hydraulic or pneumatic actuator means, or an explosion actuator means, respectively;

FIGS. 19 and 20 are longitudinal sectional views a safety leg of the anti-rollover device according to the invention, in which an actuator means of the lower portion is a selectively locked spring actuator means, respectively;

FIG. 21 is a perspective rear view of a forklift that is provided with an anti-rollover device according to a fifth exemplary embodiment of the invention, in which the safety legs of the device are shown in their rest position;

FIG. 22 is a perspective rear view of the forklift of FIG. 17 with a leg in the support safety position, in which an overturning has been avoided thanks to the device according to the invention;

FIGS. 23 and 24 show an anti-rollover device according to a sixth exemplary embodiment of the invention, configured for installation in already-existing vehicles without a cabin, and for being mounted on a vehicle during its construction;

FIGS. 26 and 27 are diagrams that show the operation of the automatic control unit for bringing one of or both the safety legs from their respective rest position to their respective support safety position.

### DESCRIPTION OF A PREFERRED EXEMPLARY EMBODIMENT

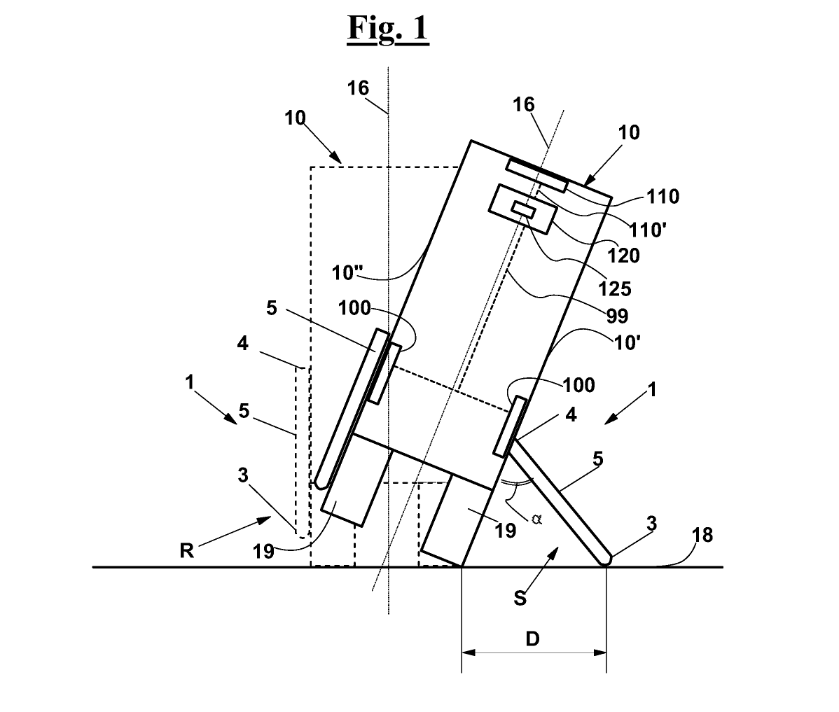

FIG. 1 is a diagrammatical front or rear view of a vehicle 10 having an anti-rollover device 1 according to an aspect of the invention. Anti-rollover device 1 comprises at least two safety legs 5, which are arranged at respective sides 10′,10″ of vehicle 10. Each safety leg 5 is connected to vehicle 10 by an own articulated end portion 4, and is movable between a rest position R, in which its encumbrance with respect to the vehicle is at a minimum, and a support safety position S, wherein a free end portion 3 is located at a predetermined support distance D from a respective side 10,10′ of vehicle 10. This way, leg 5 can rest on a support base, for example the ground 18, in a suitable way for stopping the rollover of vehicle 10. Device 1 also comprises an actuator means 100 configured for causing each safety leg 5 to move from rest position R to support safety position S, and also comprises a sensor means 110 for measuring a quantity related to an early rollover condition of vehicle 10, the sensor means configured to generate a measurement signal 110′ responsive to the value of this quantity. An automatic control unit 120, configured for receiving measurement signal 110′, comprises, according to the invention, a logical unit 125 configured for comparing signal 110′ with a limit value of the quantity measured or detected, beyond which an early rollover condition of vehicle 10 occurs. If this comparison points out an early rollover condition, logical unit 125 is configured for causing automatic control unit 120 to emit to a control signal 99 for actuator means 100 that, upon receiving said signal, impulsively brings at least one safety leg 5 from rest position R to support safety position S.

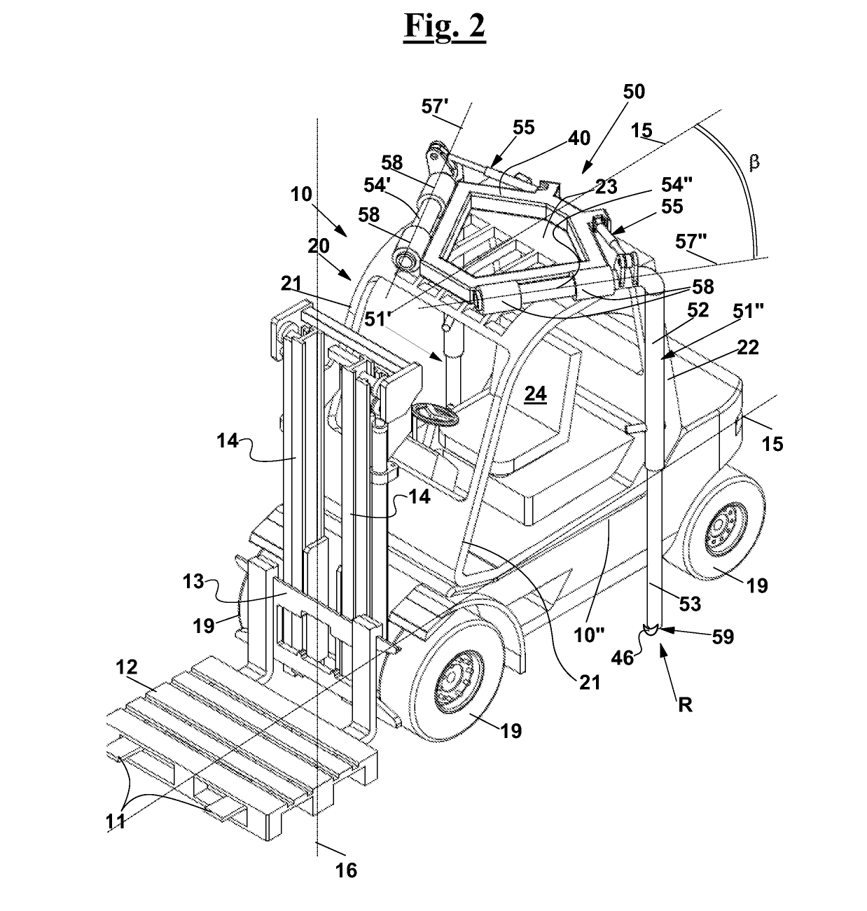

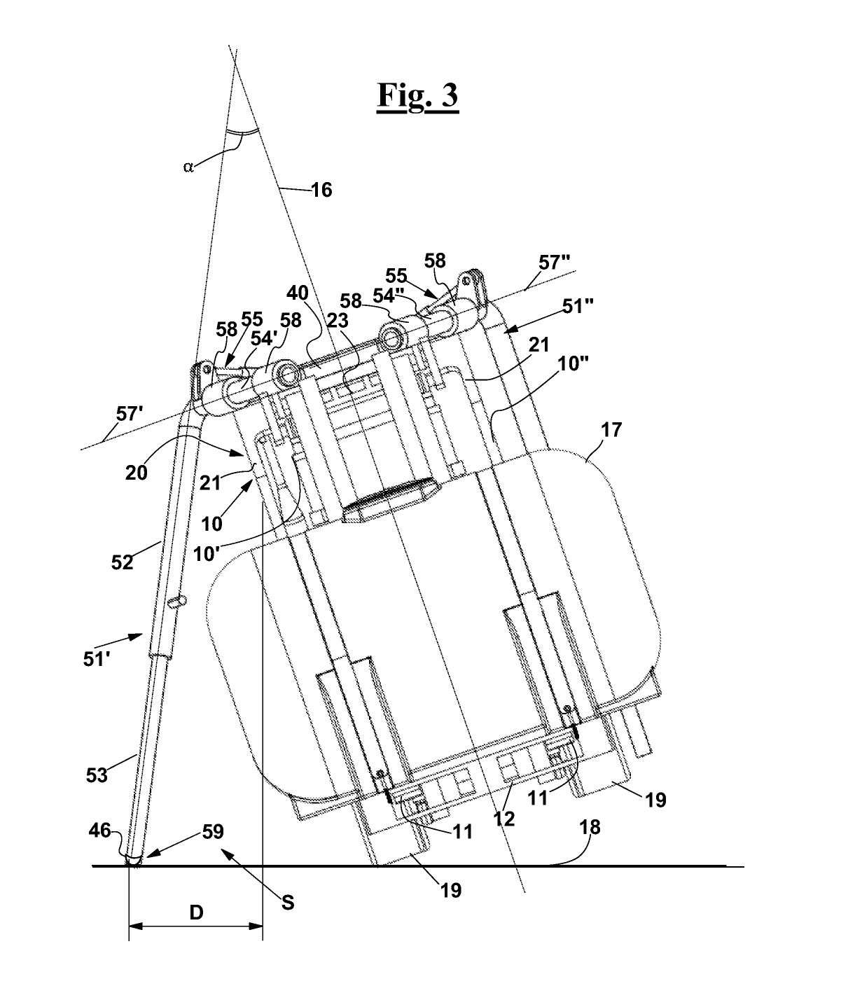

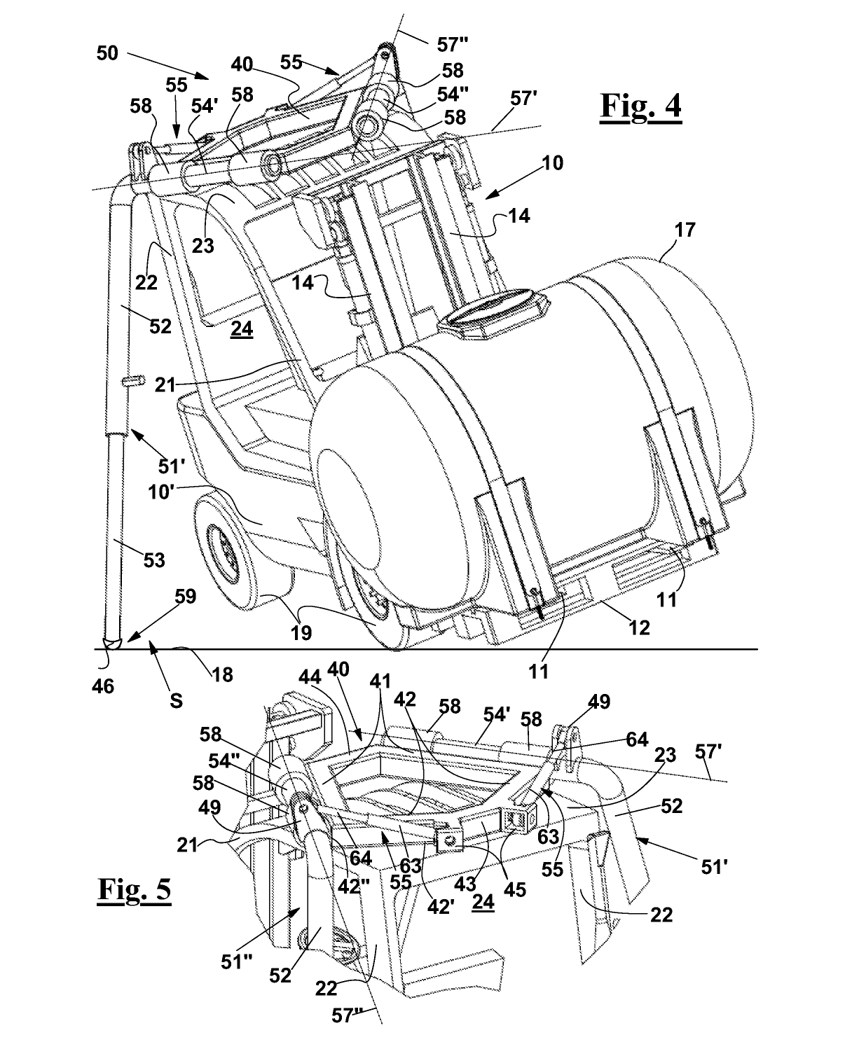

FIGS. 2 to 4 show a forklift 10 having an anti-rollover device 50 according to a first exemplary embodiment of the invention. Forklift 10 has four wheels 19, and two forks 11 connected to a frame 13 sliding vertically along a lifting guide element 14, in particular along a couple of lifting guide uprights 14 integral to forklift 10. Forks 11 can engage with a support pallet 12 for a load 17 (FIGS. 3 and 4) to be lifted and/or displaced. Forklift 10 also has a cabin structure 20 that defines a cabin 24 for a driver, not shown, and comprises a couple of front uprights 21, a couple of rear uprights 22 and a roof 23. Cabin structure 20 can be designed to serve as a roll-bar type protection structure or can be equipped with such a protection structure.

Even if these figures and the following ones always show a forklift 10 equipped with four wheels 19 and with a couple of forks 11, anti-rollover device 50 can be used for any vehicle intended for lifting and carrying a load 17, which can have three wheels instead of four, in particular it can have a a central steering wheel, not shown.

Anti-rollover device 50 comprises a couple of right and left safety legs 51′,51″, with reference to the normal travelling direction of vehicle 10, each leg configured to move between a rest position R, as shown in FIG. 2, in which it has a minimum encumbrance with respect to vehicle 10, and a support safety position S, as shown in FIGS. 3 and 4, where a free end portion 59 is located at a predetermined distance D from a respective side of vehicle 10 (FIG. 3). In its own rest position R, safety leg 51′,51″ is arranged along side 10′,10″ of vehicle 10, and has a substantially zero rest inclination with respect to a longitudinal midplane 16 of vehicle 10. In other words, safety leg 51′,51″ is substantially vertical when vehicle 10 is in a regular position upon a horizontal plane 18, and has its own free end portion 59 raised with respect to the lowest portion of wheels 19 of vehicle 10, i.e. with respect to ground 18.

FIGS. 3 and 4 show vehicle 10 in an early rollover condition, with right safety leg 51′ of anti-rollover device 50 in support safety position S. More in detail, safety leg 51′ is at an inclination angle α with respect to vertical midplane 16 of vehicle 10, and rests upon ground 18 with its own end portion 59 at a safety support distance D by side 10′, in order to provide a lateral support to vehicle 10 so as to stop a lateral overturning of vehicle 10.

In order to move from rest position R to support safety position S, each safety leg 51′,51″ is configured for carrying out a rotation about a rotation axis 57′,57″, in particular a horizontal rotation axis 57′,57″. In the exemplary embodiment of FIGS. 2 to 4, rotation axis 57′,57″ is also oriented according to an orientation angle β with respect to a longitudinal axis 15 of vehicle 10 (FIG. 2). This way, support end 59 of safety leg 51′,51″ carries out a movement that has a component longitudinal with respect to vehicle 10 same. In other words, support end 59, in support safety position S, is at a position closer to the front portion of vehicle 10, therefore nearer to forks 11 and to load 17 than in the rest position. This prevents a rotational component of the overturning to arise or to increase, which may occur with some arrangement of the masses of vehicle 10 and of load 17, when free end 59 of safety leg 51′,51″ comes into contact with ground 18, in order to reach the support safety position.

More in detail, in order to obtain orientation β between rotation axes 57′,57″ of safety legs 51′,51″ and longitudinal axis 15 of the vehicle, each safety leg 51′,51″ has one articulated end portion 54′,54″ opposite to free end portion 59 and orthogonal to the longitudinal main direction of the leg, pivotally connected to vehicle 10 through guide elements 58 that define a rotation axis 57′,57″ at an angle β with respect to the direction of axis 15 of vehicle 10.

More in detail, as shown in FIG. 5, a frame 40 is arranged upon roof 23 of cabin structure 20, comprising two side beams 41 specularly arranged with respect to each other, at orientation angle β with respect to the direction of longitudinal axis 15 of the vehicle. Two guide elements 58 are arranged along each beam 41, with their axes aligned to each other, within which articulated end portion 54′,54″ of safety leg 51′,51″ is rotatably arranged.

As described, anti-rollover device 50 also comprises actuator means 100 (FIG. 1) for bringing each of safety legs 51′,51″ from its rest position R (FIG. 2) to its support safety position S (FIGS. 3 to 5). In particular, in the exemplary embodiment of FIG. 5, a hydraulic or pneumatic actuator means 55 is provided comprising, for each safety leg 51′,51″, a hydraulic or pneumatic piston-cylinder unit 55 consisting of a cylinder 63 and of a piston 64 slideably arranged within cylinder 63 and configured for moving between an extended configuration (piston 51″), in which piston 64 protrudes from cylinder 63 for a longer portion, and a retracted configuration (piston 51′), in which piston 64 protrudes from cylinder 63 for a shorter portion. Cylinder 63 has one end portion pivotally connected to frame 40 in a housing 45. In particular, housing 45 is arranged at one end 42′ of a beam 42 adjacent to a beam 41 along which guide elements 58 are aligned, wherein end 42′ is opposite to end 42″ connecting beam 41. Piston 64 has an own free end portion, i.e. an end portion protruding from cylinder 63, pivotally connected to articulated end portion 54′,54″ of safety leg 51′,51″ in a hinge-like housing 49 offset with respect to rotation axis 57′,57″ of the rotatable mutual engagement means consisting of guide elements 58 and of articulated portion 54′,54″. This way, by actuating cylinder-piston unit 55 starting from the extended configuration towards the retracted configuration, a rotation of safety leg 51′,51″ occurs from rest position R towards support safety position S of safety leg 51′,51″, and vice-versa. In the shown exemplary embodiment, frame 40 also comprises two further front and rear connection elements 44 and 43 in the form of beams.

In an exemplary embodiment, hydraulic actuator means 55 is configured to be selectively arranged in a hydraulic connection with a hydraulic circuit, not shown, of vehicle 10, for example the actuation circuit of forks 11 or the lubrication circuit of a diesel motor of vehicle 10. The hydraulic actuator means can comprise a oil reservoir configured for being pressurized with a gas, for example nitrogen, not shown. In this case, a means is provided for notifying the pressure of the gas, and/or low gas pressure alarm means t, so that a user of vehicle 10 can assess whether actuator means 55 is adapted to operate anti-rollover device 50.

As an alternative, actuator means 100 can comprise a pneumatic actuator means 55, also shown in FIG. 5, where the piston-cylinder groups 63-64 are pneumatic groups. In particular, pneumatic actuator means 55 is configured for being selectively arranged in a hydraulic connection and for being fed by a compressor installed on the vehicle, not shown. The pneumatic actuator means can comprise a reservoir of pressurized gas, also not shown. In this case, a means is provided for notifying the pressure of the gas, and/or low pressure alarm means of the gas reservoir, so that a user of vehicle 10 can assess whether actuator means 55 is adapted to operate anti-rollover device 50.

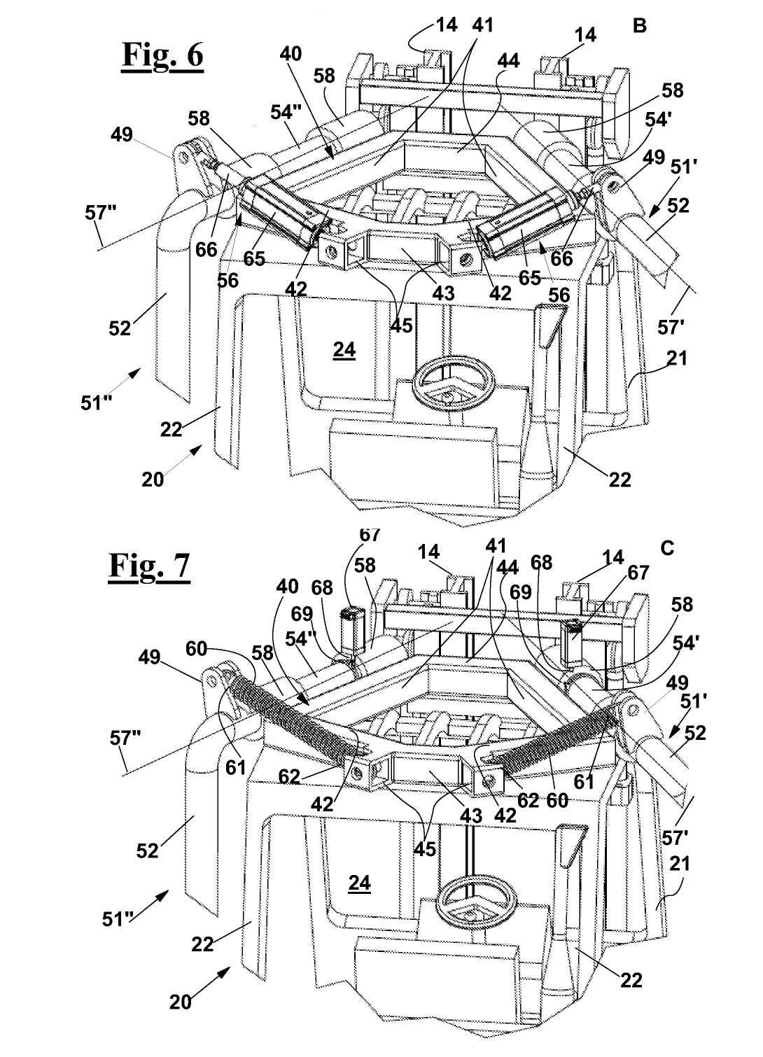

An electromechanical actuator means 56 is shown In FIG. 6, comprising, for each safety leg 51′,51″, a motor 65 and a piston 66 that can be operated by motor 65 to move between an extended configuration (leg 51″) and a retracted configuration (leg 51′). Electromechanical actuators 56 is arranged like piston-cylinder groups 63,64 of FIG. 5.

A mechanical spring means is shown in FIG. 7. In this case, an actuation spring 60 is provided for each safety leg 51′,51″, and is kept compressed when the safety leg, in this case leg 51″, is in rest position R. As shown, actuation spring 60 can be manually made ready to operate again after the use. Anti-rollover device 50 further comprises a reversible lock means 67,68,69 for locking/unlocking safety leg 51′,51″ in/from rest position R. In an exemplary embodiment, as shown, the reversible lock means comprises a lock element or tooth 69 radially protruding from articulated end portion 54′,54″ of the safety leg at one guide elements 58, and an electromechanical or hydraulic or pneumatic or different actuator 67, which operates a pin 68 that is movably arranged between a lock position (leg 51″), in which pin 68 is in an extended configuration with respect to actuator 67, and an unlock position (leg 51′), in which pin 68 is in a retracted configuration with respect to actuator 67. In the lock position, pin 68 engages with tooth 69, in order to prevent safety leg 51″ from rotating away from rest position R, maintaining safety leg 51″ in rest position R, while in the unlock position pin 68 is raised with respect to tooth 69 and allows safety leg 51′ to rotate towards the support safety position. In FIG. 7, pin 68 of right actuator 67 is in the lock position, and right safety leg 51″ is in rest position R, whereas pin 68 of left actuator 67 is in the unlock position, and safety leg left 51′ is in support safety position S. Actuation spring 60 has an own end portion 61 connected to a housing 49 integral to articulated end portion 54′,54″ of safety leg 51′,51″ and offset with respect to rotation axis 57′,57″ of the rotatable mutual engagement means consisting of guide elements 58 and of articulated portion 54′,54″. Actuation spring 60 is also provided with an end portion 62 opposite to end portion 61, which is connected to frame 40 in a housing 45. In particular, housing 45 is arranged at end 42′ of a beam 42 adjacent to beam 41 along which guide elements 58 are aligned, end 42′ being opposite to end 42″ where beam 41 is connected. Actuation spring 60 is kept stretched, when pin 68 and tooth 69 engage in the lock position, and is released, becoming contracted, when pin 68 moves to the unlock position, so as to allow safety leg 51′,51″ to rotate from the rest position to the support safety position. Even if only a spring kept compressed in the rest position R of legs 51′,51″ is shown, in FIG. 7, the actuation spring can be kept stretched in the rest position R, with modifications that are obvious for a person skilled in the art.

As described, anti-rollover device 50 (FIGS. 2 to 7) has an automatic control unit 120 configured for operating actuator means 100 (FIG. 1), for example in the form of a hydraulic or pneumatic actuator means 55 (FIG. 5), or of an electromechanical actuator means 56 (FIG. 6) or of removable lock means 67,68,69 (FIG. 7), in order to cause at least one of safety legs 51′,51″ to rotate from rest position R to support safety position S, in the case of an early lateral overturning condition of vehicle 10.

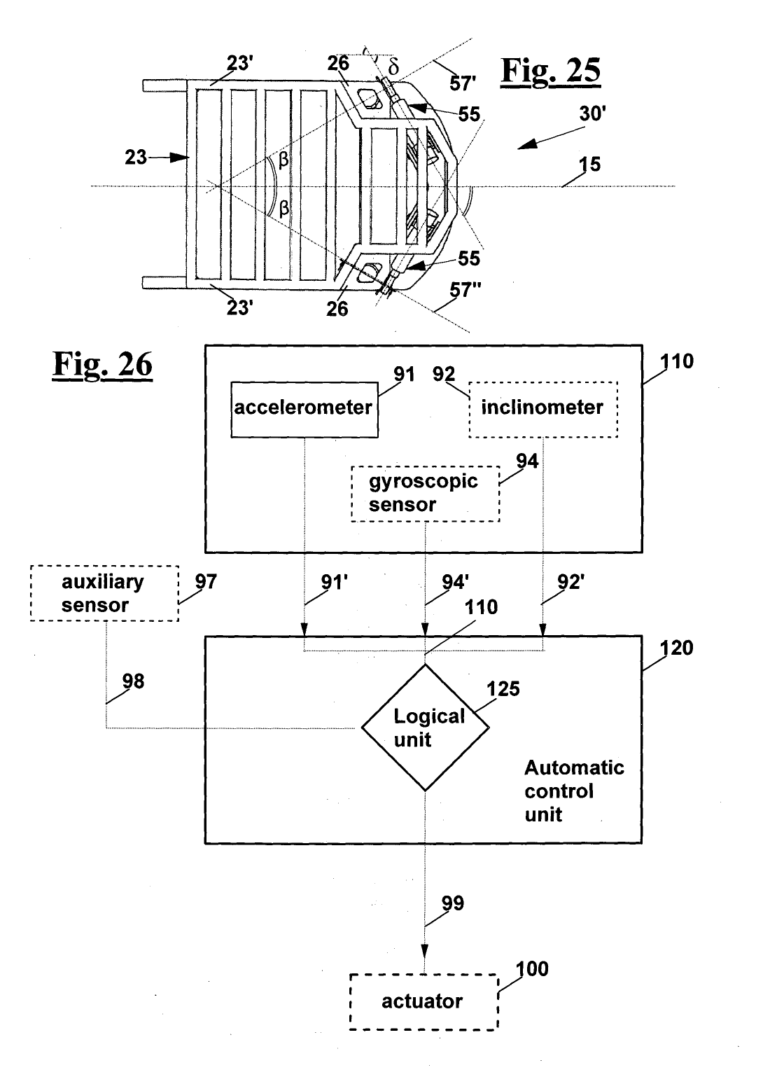

More in detail, as shown in the diagram of FIG. 26, anti-rollover device 50 comprises a sensor means 110 arranged on board of vehicle 10, not shown in FIGS. 2 to 4, for measuring the values of at least one physical quantity related to a possible overturning of vehicle 10, and for generating at least one electric measurement signals 110′, respectively, whose intensity depends upon the values measured of such physical quantity or quantities. For instance, sensor means 110 can comprise an inertial sensor, in particular an accelerometer 91 configured for measuring components of a lateral acceleration of vehicle 10, i.e. acceleration components that are orthogonal to longitudinal direction 15, and also configured for producing an electric lateral acceleration signal 91′ responsive to these acceleration components.

As an alternative, or in addition, sensor means 110 can comprise a gyroscopic sensor 92 for detecting the orientation of vehicle 10, and configured for producing an electric orientation signal 92′ of vehicle 10.

As an alternative, or in addition, sensor means 110 can comprise an inclinometer 94 arranged for detecting the lateral inclination of vehicle 10, i.e. the inclination in a transversal direction with respect to longitudinal axis 15 of vehicle 10, and configured for producing an electric inclination signal 94′ vehicle 10.

Automatic control unit 120 comprises, according to the invention, a logical unit 125 configured for receiving electric measurement signal or signals 110′, for example lateral acceleration signal 91′ and/or orientation signal 92′ and/or inclination signal 94′, and for causing automatic control unit 120 to emit a control signal 99 for operating actuator means 55,56,67 of a safety leg 51′,51″ according to at least one of electric measurement signals 110′ or to a combination of these electric measurement signals 91′,92′,94′ coming from sensor means 100, in order to bring at least one of, or both, safety legs 51′,51″ to support safety position S, or in any case to a position corresponding to support safety position S.

In particular, logical unit 125 can be configured for carrying out a comparison of value of acceleration signal 91′ and/or of orientation signal 92′ and/or of inclination signal 94′ with a respective predetermined safety or stability limit value, established by experience or calculated.

In another exemplary embodiment, logical unit 125 can be configured for carrying out a comparison of a combination of the values of acceleration signal 91′ and/or orientation signal 92′ and/or inclination signal 94′ with combinations of stability limit values established by experience or calculated. In this case, at least one inertial sensor 91 and/or gyroscopic sensor 92 and/or inclinometers 94 can form different detection chains, so as to obtain redundant electric measurement signals 110′.

Logical unit 125 is configured for causing automatic control unit 120 to emit an electric control signal 99 for operating actuator means 100 if the comparison carried out by logical unit 125 points out an immediately subsequent or early overturning condition of vehicle 10. Control signal 99 can be received by actuator means 100, i.e. 55,56,67, which is configured for causing or allowing one or both safety legs 51′,51″ to move from rest position R (FIG. 2) to support safety position. S (FIGS. 3 and 4), upon receiving said control signal 99.

Anti-rollover device 50 can comprise a plurality of chains of sensor means 100 and of logical means 125, configured in such a way that actuator means 55 of the rotation of safety legs 51′,51″ is operated only if a control signal comes from all or from most of the chains, or anti-rollover device 50 can comprise a plurality of inertial sensors, and logical unit 125 causes automatic control unit 120 to generate control signal 99 only if most or all the sensors point out an immediately subsequent or early overturning condition of vehicle 10, to avoid unwanted and unnecessary actuation of safety legs 51′,51″.

FIG. 26 also shows, in dotted line to refer to a particular exemplary embodiment, an auxiliary signal 98 fed to automatic control unit 120, generated by an auxiliary sensor 97, in order to generate a permission signal to allow actuator means 100 of at least one safety leg to emit control signal 99 only if auxiliary signal 98 exceeds a predetermined threshold value. Typically, auxiliary sensor 97 can measure a quantity related to a ground contact condition 18 or to a ground no-contact condition 18 of at least one wheel 19 of vehicle 10, preferably by detecting the distance of a vehicle portion such as the bottom of vehicle 10 from the ground, in particular the distance of the bottom at one of the sides of vehicle 10, or by a plurality of force sensors each arranged for measuring the weight resting on a respective wheel 19 of vehicle 10, typically by strain gauges arranged at a support or at the suspension of each wheel.

Advantageously, the automatic control unit is configured to generate a block signal that engages a connection means configured for connecting in a control unit for controlling vehicle 10 or in a chain of driving vehicle 10 to block the motor of vehicle 10 control signal 99 is emitted and/or if permission signal 98 and/or a failure signal is present in at least one detection means 110 or in at least one auxiliary sensor 97.

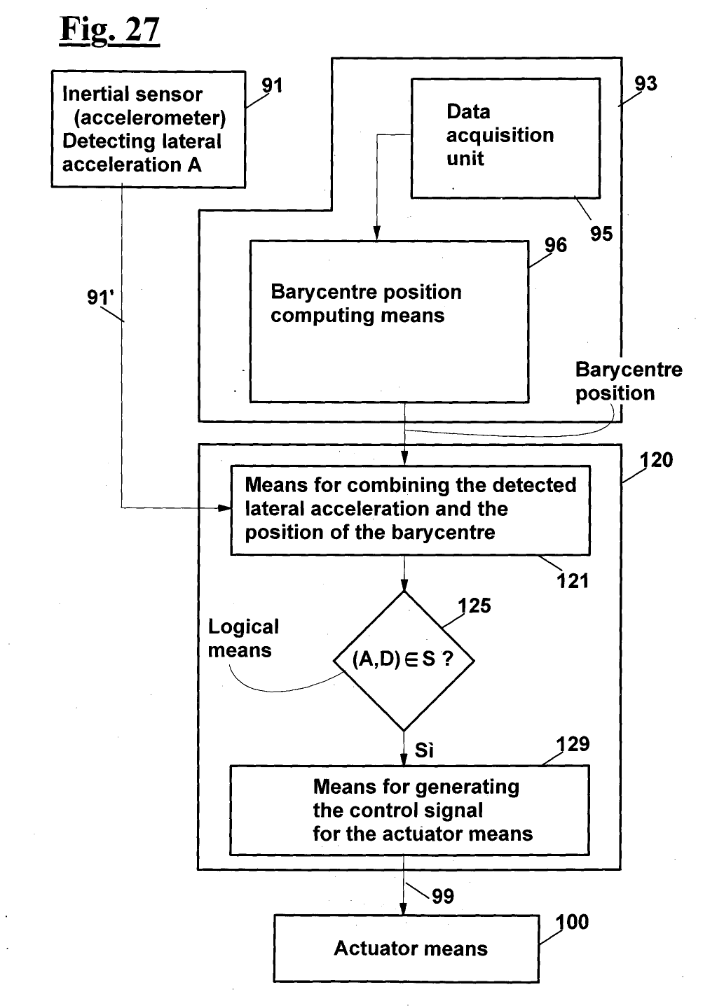

The diagram of FIG. 27 it relates to an exemplary embodiment in which device 50 comprises a barycentre computation means 93 for computing the position of the barycentre of the group consisting of vehicle 10, load 17 (FIGS. 3 and 4) and the driver. This exemplary embodiment of the device is useful for a vehicle arranged to lift loads, such as a forklift. In particular, barycentre computation means 93 is configured for determining the distance of the barycentre from longitudinal midplane 16 of vehicle 10.

More in detail, barycentre computation means 93 can comprise a data acquisition unit 95, for example a data input section of a control panel, configured for receiving weight data W and volume data V of load 17 and preferably of lift truck 10 and preferably of the driver of lift truck 10. In particular, the data W and/or V of vehicle 10 can be predetermined in a memory unit, not shown, of automatic control unit 120, when device 50 is installed on vehicle 10, and/or the data W and/or V of the driver can be predetermined average data, also recorded in the memory unit. Moreover, data acquisition unit 95 can be configured for receiving current elevation data of load 17.

Furthermore, barycentre computation means 93 can comprise a computing means 96 for computing the position of the barycentre, starting from the data acquired from data acquisition unit 95.

In this exemplary embodiment, automatic control unit 120, or logical unit 125 thereof, is configured for receiving the position of the barycentre as calculated by barycentre computation means 93. In particular, as shown in FIG. 27, automatic control unit 120 can comprise a means 121 for combining the position of the barycentre with measurement signal 91′ generated by inertial sensor 91, as shown in FIG. 27, and/or with measurement signal 92′ generated by gyroscopic sensor 92, and/or with measurement signal 94′ generated by inclinometer 94. This way, the position of the barycentre of the system vehicle-loading-driver can be used by logical means 125 of automatic control unit 120 in combination with acceleration signal 91′, as shown in FIG. 27, in addition or as an alternative to orientation signal 92′ coming from gyroscopic sensor 92, and/or in addition or as an alternative to inclination signal 94′ coming from inclinometer 94, in order to establish the stability or instability conditions, i.e. an immediately subsequent or early overturning condition of the lifting vehicle 10, and therefore in order to operate actuator means 100 of safety legs 5 or 51′,51″.

In addition, device 50 can comprise a manual drive unit, not shown, accessible to the driver when the latter engages the drive seat of lift truck 10, in order to manually operate actuator means 55,56,67. For instance, the manual drive unit may have the shape of an emergency button.

Still with reference to FIGS. 2 to 4, each safety leg 51′,51″ comprises an upper portion 52 and a lower portion 53 configured for slideably engaging with upper portion 52 according to the common direction of the longitudinal axes of both portions 52 and 53. In particular, upper portion 52 has an inner cavity, therefore it has a hollow cross section, and lower portion 53 is slideably arranged within the inner cavity of upper portion 52, forming a telescopic coupling. For instance, upper portion 52 can be a cylindrical hollow portion having a predetermined inner diameter, and lower portion 53 can be a cylindrical portion having an outer diameter smaller than the inner diameter of upper portion 52. In a safety leg comprising upper and lower portions 52 and 53 slideably engaged with respect to each other, lower portion 53 can slide between a rest protrusion length, and a safety protrusion length, where the rest protrusion length and the safety protrusion length respectively correspond to the rest configuration and to the safety support configuration of safety leg 51′,51″, with respect to vehicle 10.

The slide movement of lower portion 53 with respect to upper portion 52 can be operated by means of a hydraulic actuator means, diagrammatically shown in FIGS. 17 and 18. In this case, upper portion 52 and lower portion 53 of each safety leg 51′,51″ are made respectively in the form of a cylinder 52 and of a piston 53 sliding within said cylinder. The hydraulic actuator means comprises a pressurization chamber 72 obtained in a closed end portion of cylinder 72, equipped with at least one inlet/outlet opening, not shown for an actuation fluid.

In another exemplary embodiment, cylinder 52 and piston 53 can form a pneumatic piston-cylinder unit, in which pressurization chamber 72 is configured for receiving a gas as an actuation fluid, typically compressed air.

In particular, pressurization chamber 72 is selectively connected with a reservoir or a bottle containing a high pressure gas through a passageway at which selective open/close means are arranged, configured to open upon a sudden movement of the safety leg, as it occurs when the actuator means of the rotation of leg 51′,51″, with respect to vehicle 10, are operated, to obtain a device similar to a car air-bag. In particular, the reservoir containing high pressure gas can be arranged within pressurization chamber 72.

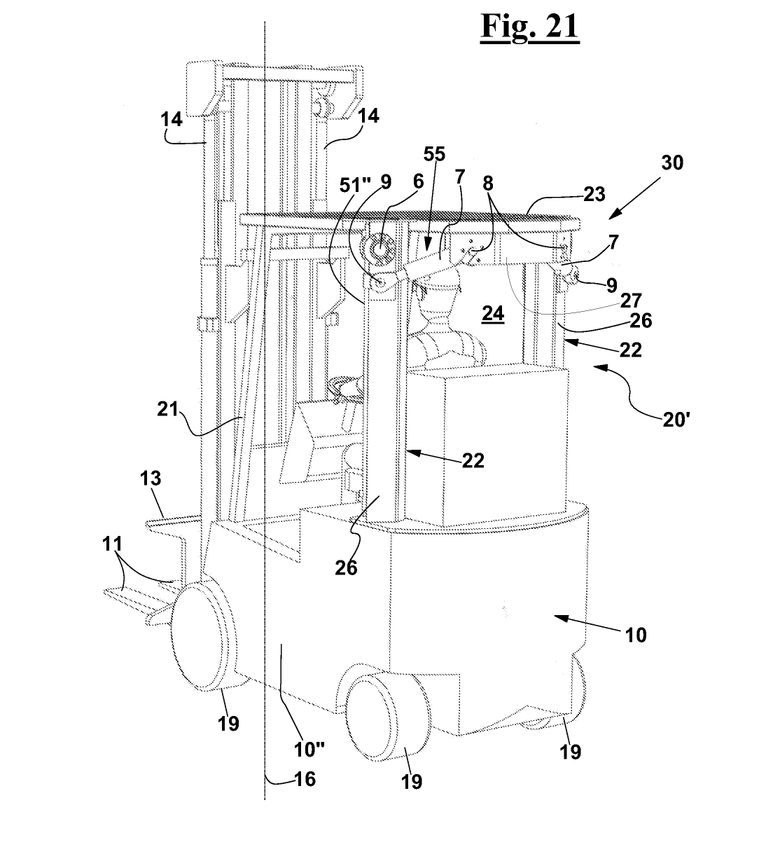

A leg 51′ of the safety device is shown in FIGS. 17 and 18, according to two exemplary embodiments of the invention that are shown in FIGS. 21 to 22 and 23 to 24, and that are described below. In particular, actuation means 55 is shown for actuating the rotation of the piston with respect to side 10′ of vehicle 10, and a rear upright 26 of cabin 20 is also shown having an inner cavity configured for receiving leg 51′ when piston 53 is in a contracted position with respect to cylinder 52, i.e. when safety leg 51 is in its rest position. However, a leg that has a structure of a cylinder-piston unit with pressurization chamber 72 between the end of piston 53 and a corresponding closed end 73 of cylinder 52 can be used also in the exemplary embodiments described before. In this case, leg 51′ comprises a first and a second rod 52,53, wherein the second rod is slideably arranged in a first longitudinal cavity of the first rod, and is in turn equipped with a longitudinal cavity. A compression spring 71 is arranged within the first longitudinal cavity and the second longitudinal cavity, arranged between respective abutment surfaces 52′,53′, in order to be compressed when second hollow rod 53 is arranged in a contracted position i.e. it is arranged within the first hollow rod 53. Leg 51′ further comprises a selective lock means 74 for locking the slide movement of second rod 53 with respect to first rod 52, and of a preferably mechanical unlock actuator, not shown, for deactivating lock means 74 so as to cause second rod 53 to slide towards an extended configuration, protruding out of first hollow rod 52.

The slide movement of lower portion 53 with respect to upper portion 52 can be operated by means of a selectively lockable spring mechanical actuator means, as diagrammatically shown in FIGS. 19 and 20, in this case.

The actuator means of the slide movement of lower portion 53 with respect to upper portion 52 is preferably operated according to a same condition that causes the rotation of articulated end portion 54′,54″ and of upper portion 52 with respect to vehicle 10, to cause safety leg 51′,51″ to move from rest position R to support safety position S. To this purpose, the actuator means of the relative slide movement can be operated by automatic control unit 120 (FIGS. 1,23,24) that operates actuator means 55 for actuating the rotation of safety leg 51′,51″. In particular control signal 99, by which actuator means 55,56,67 is operated for causing articulated end portion 54′,54″ and upper portion 52 to rotate, also operates the actuator means of the slide movement of lower portion 53 with respect to upper portion 52.

In an exemplary embodiment, anti-rollover device 50 comprises a selective unidirectional sliding means of lower portion 53 with respect to upper portion 52 of each safety leg 51′,51″, which allow lower portion 53 to increase the length of its own portion protruding out of upper portion 52, but do not allow it to decrease, under the effect of the reaction force acting on lower portion 53 through free end 59, when the latter hits ground 18 upon reaching the support safety position, and when it is in contact with ground 18. The selective unidirectional sliding means can comprise a removable unidirectional mechanical lock means of portions 53,52, for example a ratchet mechanism, designed for resisting to the reaction force of the ground. As an alternative, or in addition, in the case of a hydraulic actuator means, the selective unidirectional sliding means can comprise a non-return device, such as a check valve, arranged along an oil feed duct feeding actuation oil to a hydraulic actuator means of lower portion 53, if present.

As an alternative, safety leg 51 can simply comprise a lock/unlock means for locking/unlocking the slide movement of lower portion 53 with respect to upper portion 52, configured to move from a lock configuration, in which lower portion 53 is locked at the rest protrusion length, and an unlock configuration, in which lower portion 53 is free to slide with respect to upper portion 52 under the effect of its own weight and of inertial forces that act on lower portion 53, wherein slide means 53 can be deactivated in order to restore the rest protrusion length. This lock/unlock means of the slide movement of lower portion 53 with respect to upper portion 52 can be brought to its unlock configuration by automatic control unit 120 similarly to a previously described exemplary embodiment of the device, in which the automatic control unit operates the actuation means for moving sliding lower portion 53 with respect to upper portion 52. This way, when safety leg 51′,51″ moves from rest position R to support safety position S, the lower portion slides under the effect of its own weight and of inertial forces, until it abuts against ground 18, then maintaining the corresponding protrusion length.

The rest protrusions length is selected in such a way that free end portion 59 of safety leg 51′,51″ is at a predetermined height with respect to the lowest portion of wheels 19 of vehicle 10, i.e. with respect to ground 18. The safety protrusion length can be predetermined in such a way that support end 59 comes into contact with the ground in a predetermined position with respect to vehicle 10, when reaching the support safety position, in particular in a position at a safety distance D from vehicle 10.

Preferably, free end portion 59 of safety leg 51′,51″ has a rounded end part 46, for example a hemispheric end part, to allow end portion 59 to slide when it comes into contact with ground 18. As an alternative, free end portion 59 can be equipped with a support plate to be engaged with the ground, not shown, which is preferably articulated with respect to safety leg 51′,51″.

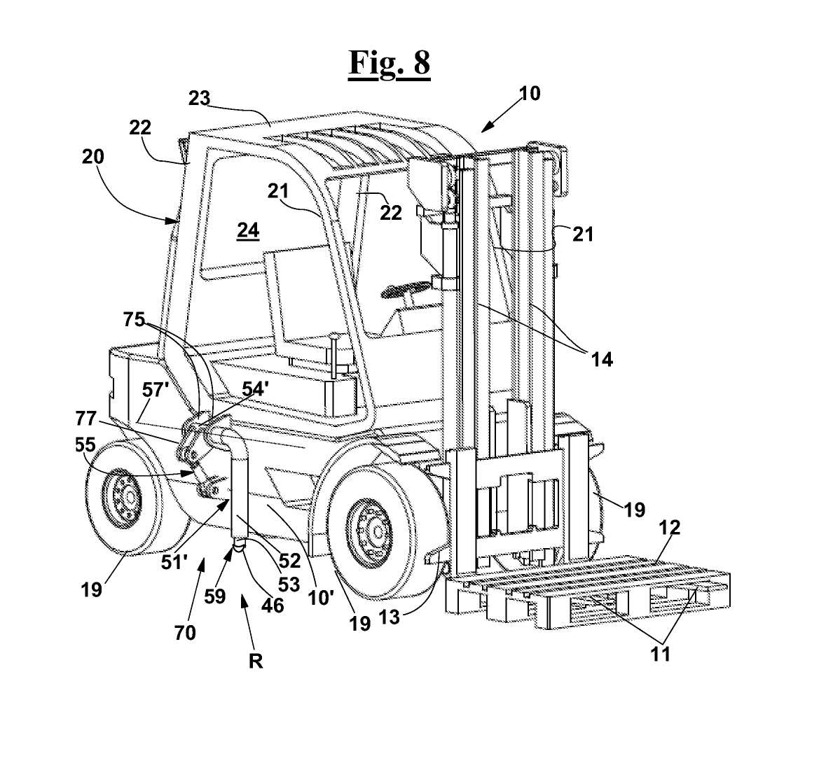

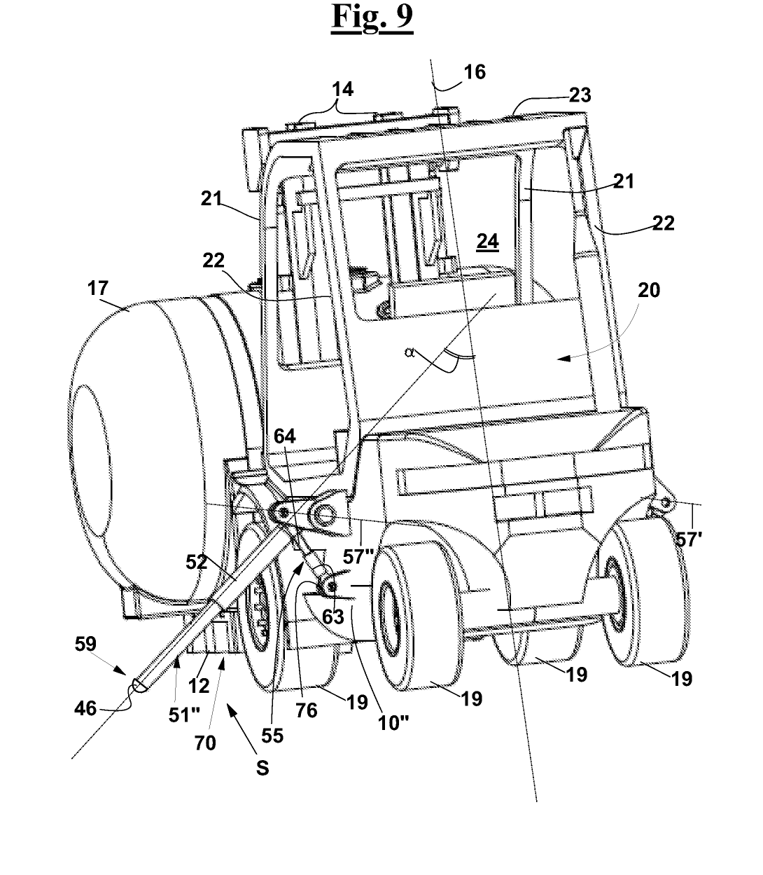

FIGS. 8 and 9 show a forklift 10, similar to the vehicle shown in FIGS. 2 to 4, provided with an anti-rollover device 70 according to a second exemplary embodiment of the invention. Anti-rollover device 70 differs from device 50 substantially in that it does not comprise frame 40 (FIG. 2) and in that articulated end portion 54′,54″ of safety legs 51′,51″ is pivotally connected to vehicle 10 through a guide element 75, which can belong to device 70, which is fixed to side 10′,10″ of vehicle 10, for example below cabin 24 of vehicle 10.

In the figures, an actuator means 55 is shown for causing safety leg 51′,51″ to move from rest position R to support safety position S, comprising a hydraulic or pneumatic piston-cylinder unit 55, whose cylinder 63 has one end portion rotatably connected to a housing 76 of the side of vehicle 10, and piston 64 has its own end portion that is outside of the cylinder, i.e. that is opposite to said end portion of the cylinder, which is rotatably connected to a housing 77 of articulated end portion 54′,54″ of safety leg 51′,51″ and offset with respect to axis 57′,57″ of articulated end portion 54′,54″. However, as an alternative to this kind of hydraulic actuator means, an electromechanical actuator means can be used, as well as a mechanical release means that can be manually made ready to operate again after the use, as described above with reference to the first exemplary embodiment of the invention and to FIGS. 6 and 7. Furthermore, also in this case, the anti-rollover device can comprise a sensor means 110 and an automatic control unit 120 configured for working as described with reference to the first exemplary embodiment of the invention.

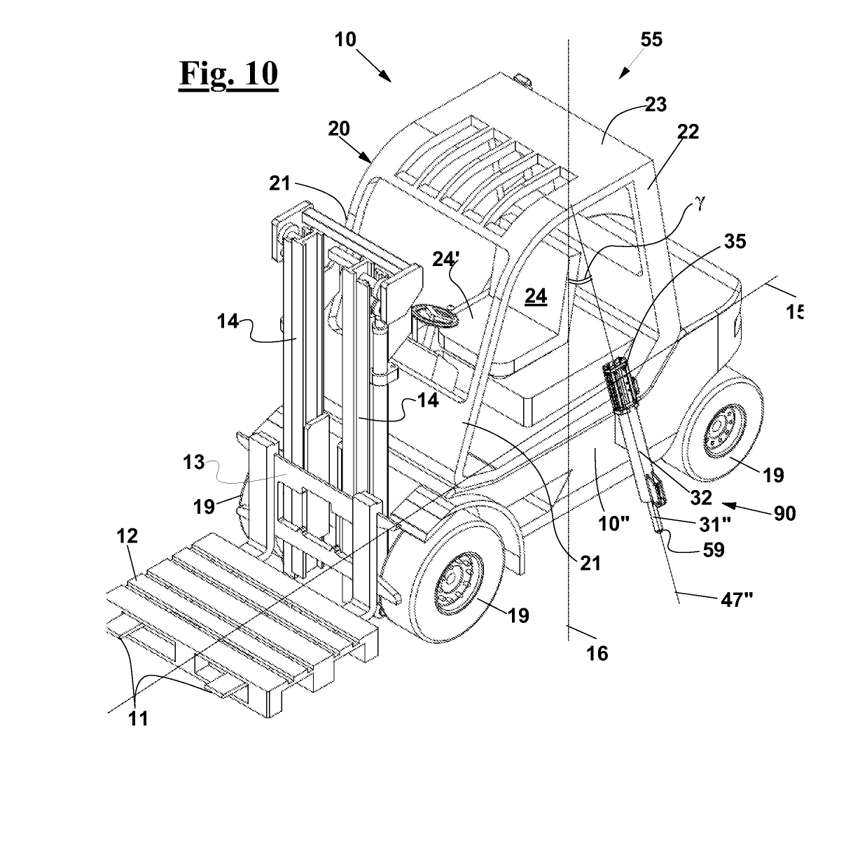

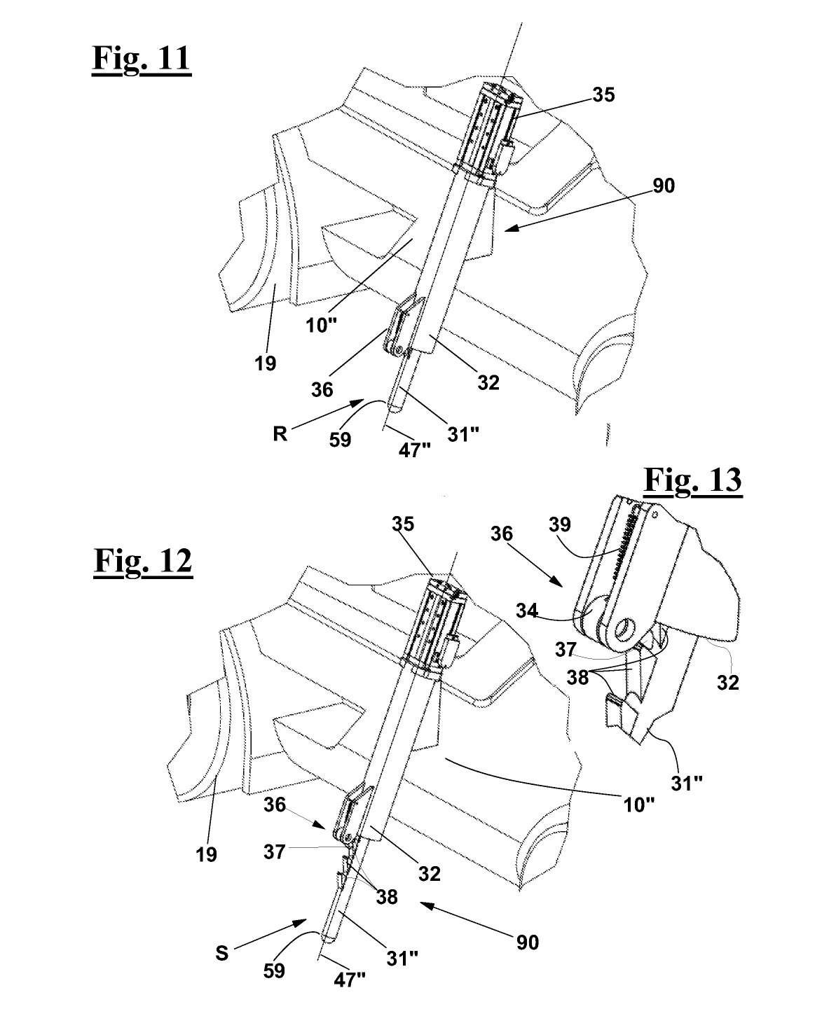

FIGS. 10 to 12 show a forklift 10 similar to the vehicle shown in FIGS. 2 to 9, which is equipped with an anti-rollover device 90 according to a third exemplary embodiment of the invention. Anti-rollover device 90 comprises a couple of safety legs 31′,31″, each of them arranged to slide between a rest position R (FIG. 11) and a support safety position (FIG. 12), outwards of vehicle 10, along a respective slide direction 47′,47″ at an angle γ with respect to vertical midplane 16 of vehicle 10. In its rest position, safety leg 31′,31″ has an own free end portion 59 raised with respect to the lowest portion of wheels 19 of vehicle 10, i.e. with respect to ground 18. In the support safety position, free end portion 59 is located substantially at a same height of the lowest portion of wheels 19, by the same side of vehicle 10.

In order to move from the rest position to the support safety position, each safety leg 31′,31″ is configured for translating along slide direction 47′,47″. More in detail, each safety leg 31′,31″ has an own articulated end portion, opposite to free end portion 59, not shown in the figures, which is slideably connected with a slide guide 32 arranged on side 10″ of vehicle 10 and at an angle γ with respect to longitudinal midplane 16 of vehicle 10, i.e. oriented according to slide direction 47′,47″. The slide guide, in the case shown, has an inner cavity within which safety leg 31′,31″ is slideably engaged. For example, as shown in the figures, slide guide 32 is connected to the side of vehicle 10, in particular below cabin 24 of vehicle 10. As an alternative, the slide guide can protrude inside the outline of vehicle 10. In particular, slide guide 32 can be arranged behind a driver seat 24′.

In order to cause safety leg 31′,31″ to slide along respective slide direction 47′,47″, an actuator means is provided, in case of the device of FIGS. 10 to 12, comprising an electromechanical actuator 35. The electromechanical actuator can be of one of the types indicated when describing FIG. 6.

As shown in FIGS. 11 to 13, in an exemplary embodiment, the mutual engagement means between safety leg 31′,31″ and vehicle 10 comprises a non-return means 36 of the slide movement, in this case a ratchet mechanism 36 comprising a plurality of sawtooth elements 38 arranged along safety leg 31″ and an engagement tooth 37 protruding from a rotatable support element 34 arranged along slide guide 32, in such a way to engage with the back portions of sawtooth elements 38. A return spring 39 can be provided that has a first end connected to slide guide 32 and a second end peripherally connected to the rotatable support element 34, in order to keep the engagement tooth 37 oriented towards safety leg 31″ and then arranged to engage an adjacent sawtooth element 38, when each sawtooth element 38 is disengaged under due to the slide movement.

Obviously, as an alternative to electromechanical actuator means 35 shown above, a hydraulic or pneumatic actuator means can be used. As an alternative, a mechanical release means that can be manually made ready to operate again after the use can be provided, comprising a previously compressed actuation spring fixed to slide guide 32, in particular arranged within the latter. Moreover, also in this case, the anti-rollover device can comprise a sensor means 110 and an automatic control unit 120 configured for working as described with reference to the first exemplary embodiment of the invention.

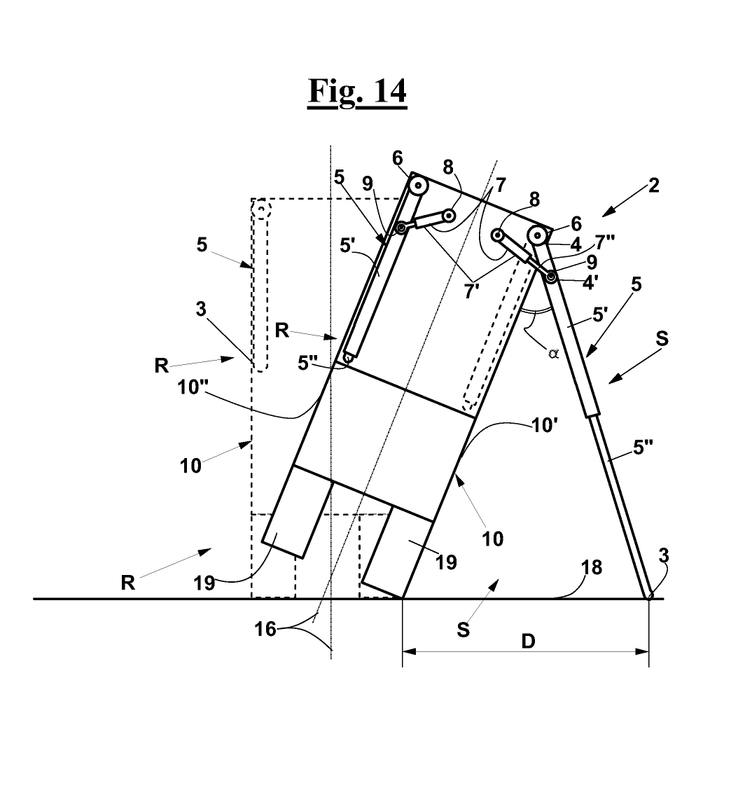

FIG. 14 is a diagrammatical front or rear view of a vehicle 10 having an anti-rollover device 2 according to another aspect of the invention. Also anti-rollover device 2 comprises at least two safety legs 5, which are arranged at respective sides 10′,10″ of vehicle 10. Each safety leg 5 is connected to vehicle 10 at an own articulated end portion 4, through a hinge 6. Each safety leg 5 is also connected to vehicle 10 at an own intermediate portion 4′, at a predetermined distance from end portion 4, through an adjustable length element 7. Adjustable length element 7 can be, as shown, a unit consisting of a cylinder 7′ and of a piston 7″ slideably arranged within cylinder 7′, with the opposite ends of cylinder 7′ and of piston 7″ pivotally constrained to vehicle 10 and to leg 5, respectively, or vice-versa, i.e. forming two hinges 8 and 9. Each safety leg 5, rotating about hinge 6, is pivotally movable between a rest position R, in which it has a minimum encumbrance with respect to the vehicle, and a support safety position S, wherein a free end portion 3 is located at a predetermined support distance D from respective side 10,10′ of vehicle 10. This way, leg 5 can rest on a support base, for example ground 18, in such a way to stop the rollover of vehicle 10.

Moreover, also in this case, the anti-rollover device can comprise a sensor means 110 and an automatic control unit 120 configured for working as described with reference to the first exemplary embodiment of the invention.

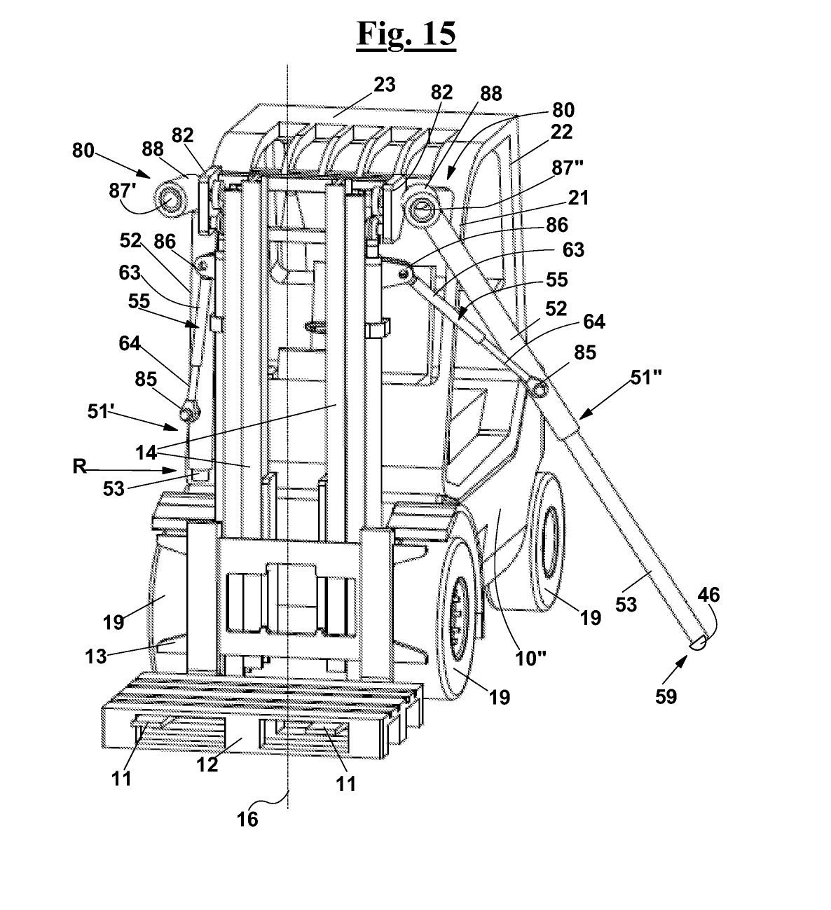

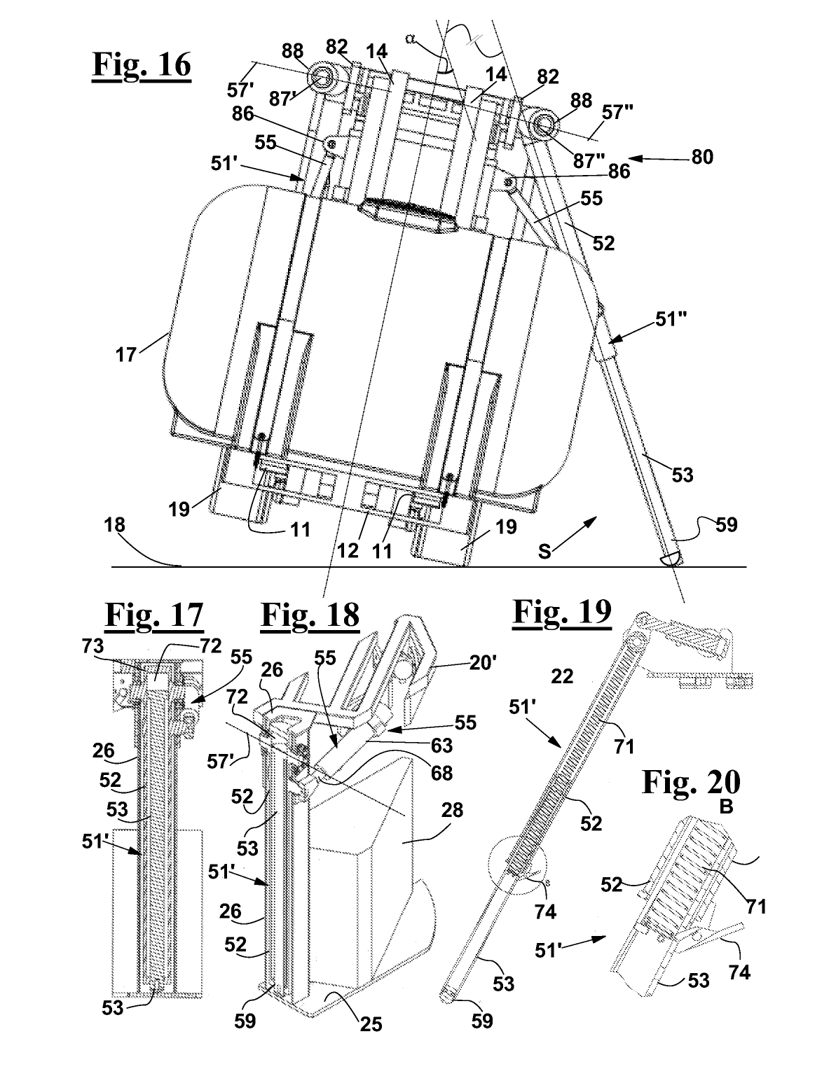

FIGS. 15 and 16 show a forklift 10 similar to the forklift shown in FIGS. 2 to 9, which has an anti-rollover device 80 according to a fourth exemplary embodiment of the invention. Like anti-rollover devices 50 and 70, anti-rollover device 80 comprises a couple of safety legs 51′,51″ each rotatably arranged between a rest position R and a support safety position S in which safety leg 51′,51″ turns from an orientation that is substantially the same as the orientation of vertical midplane 16 of forklift 10, to an inclination α with respect to vertical midplane 16 of forklift 10 (FIG. 16). FIG. 16 shows forklift 10 in an early rollover condition, with safety leg left 51″ in the support safety position.

In the exemplary embodiment of FIG. 15, safety leg 51′,51″ is arranged in such a way to have, when in rest position R, lower end 59 above a wheel housing 19′ of vehicle 10, which is more narrow than the profile of the vehicle, along which safety leg 51′,51″ is arranged when in rest position R.

In order to move from the rest position to the support safety position, each safety leg 51′,51″ is configured for carrying out a rotation about a rotation axis 57′,57″, for example, a horizontal axis. More in detail, each safety leg 51′,51″ has one end portion 87′,87″, preferably orthogonal to its own longitudinal direction, that is rotatably connected to forklift 10 in a connection element such as a bush 88 fixed to forklift 10 at a top portion of a lifting means of forklift 10, in particular at a top of a couple of guide uprights 14, in this case through a frame 82 integral to guide uprights 14.

In order to cause the rotation of each safety leg 51′,51″ about respective rotation axis 57′,57″, an actuator means 55 is provided comprising, in the case of the device of FIGS. 15 and 16, and for each safety leg 51′,51″, hydraulic or pneumatic piston-cylinder unit 55, whose cylinder 63 has one end portion rotatably connected in a housing 86 of a frame 84, with which it forms a hinge 8 (FIG. 14), while piston 64 has an own end portion, outside of the cylinder, i.e. opposite to the above engaged end portion of cylinder 63, rotatably connected to a housing 85 of safety leg 51′,51″, with which it forms a hinge 9 (FIG. 14). This way, by operating cylinder-piston unit 55 starting from its retracted configuration towards the extended configuration, safety leg 51′,51″ is caused to rotate from rest position R towards support safety position S, and vice-versa.

Obviously, as an alternative to the above shown hydraulic or pneumatic actuator means, an electromechanical actuator means as well as a mechanical release means that can be manually made ready to operate again after the use can be provided, comprising a previously compressed actuation spring, similarly to what has been described with reference to the first exemplary embodiment of the invention. Moreover, also in this case, an automatic control unit can be provided of the type described with reference to the first exemplary embodiment of the invention and to FIGS. 6 and 7.

Also in this case, each safety leg 51′,51″ can comprise a lower portion 53 slideably arranged, in particular telescopically arranged with respect to an upper portion 52, wherein the slide movement can be actuated by the automatic control unit 20 that causes safety leg 51′,51″ to rotate.

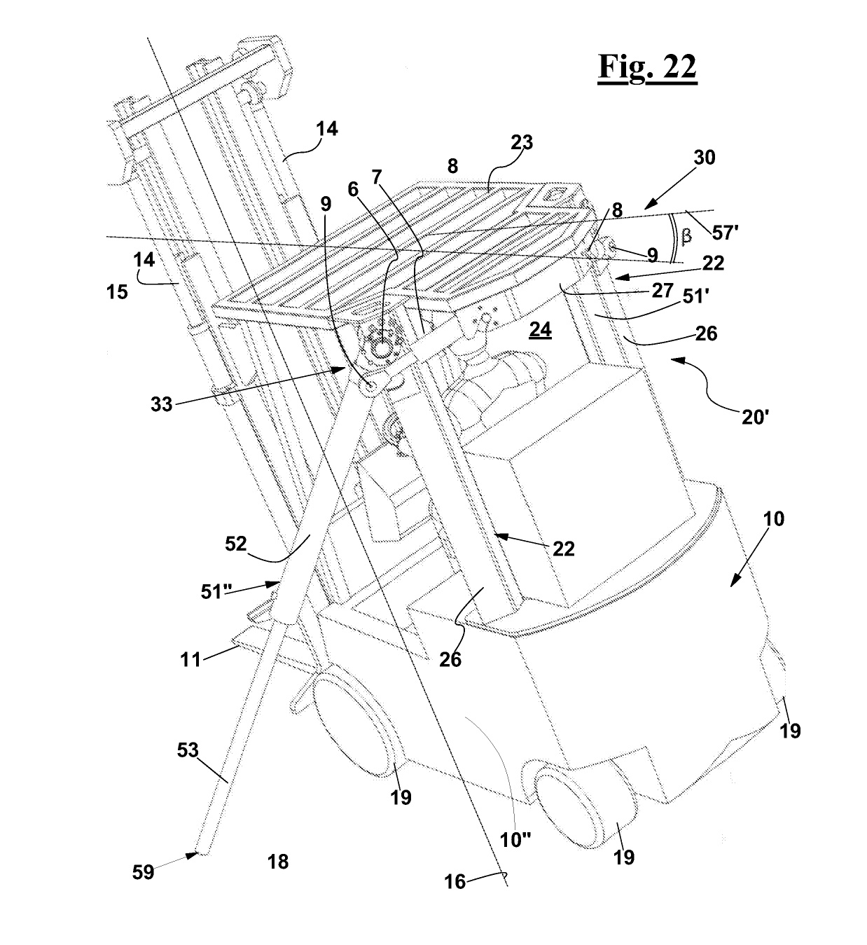

FIGS. 21 and 22 show a forklift 10 having an anti-rollover device 30 according to a fifth exemplary embodiment of the invention, wherein each of safety legs 51′,51″ has one end portion 33 (FIG. 18) arranged to be pivotally connected to an upper portion of a respective right or left rear upright 22 of cabin structure 20′. Preferably, each safety leg 51′,51″ is configured to be mounted in such a way that rotation axis 57′,57″ forms an orientation angle β with respect to longitudinal axis 15 of vehicle 10, as shown in FIG. 25, so that, when safety leg 51′,51″ is caused to rotate, it forms an angle δ=π−β with longitudinal axis 15, therefore it becomes closer to the front portion of vehicle 10, and so that end portion 59 of leg 10 hits ground 18 in a more forward position with respect to rear uprights 22. In order to cause the rotation of each safety leg 51,51″ about respective rotation axis 57′,57″, an actuator means 55 is provided similar to that of device 80 of the fourth exemplary embodiment, and described with reference to FIG. 14 and to FIGS. 15 and 16.

The devices according to exemplary embodiments described so far are adapted to be mounted to existing vehicles, in particular to lift trucks that have a cabin structure 20. These devices provide a retrofit solution for such existing vehicles.

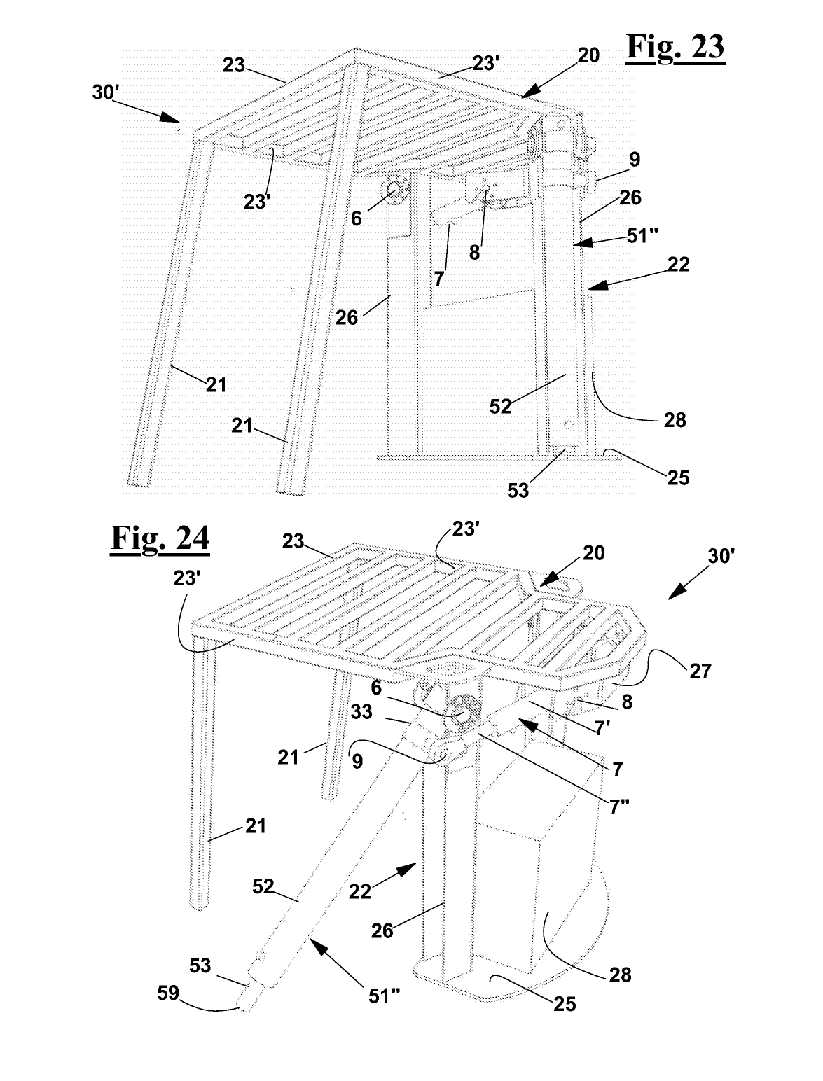

With reference to FIGS. 23 to 25, an anti-rollover apparatus or device 30′ is described according to a sixth exemplary embodiment of the invention, in a third aspect of the present invention, which is adapted to be installed on an existing vehicles without cabin and to be mounted to a vehicle when being assembled. Device 30′ comprises a cabin structure 20 in which a roof 23′ is provided, in this case a roof comprising transversal elements that can be substantially parallel to each other, and which extend between two side elements 23′. Two couples of front and rear uprights 21 and 26, respectively, extend from roof 23. Legs 51′,51″ of anti-rollover device 30′ are arranged, with respect to rear uprights 26, so as to be in a concealed location, within the profile of cabin structure 20, when they are in their own rest position R. For instance, each rear upright 26 can provide a longitudinal housing or concave portion 26′ configured for receiving a respective safety leg 51′ or 51″, when the latter is in rest position R. A hinge element 6 is provided at an upper portion of each rear upright 26, with which end portion 33 of respective safety leg 51′ or 51″ is connected.

In order to cause each safety leg 51′,51″ to rotate about respective rotation axis 57′,57″, an actuator means 55 is provided similar to the one provided in the fourth and in the fifth exemplary embodiment of the safety device, in which hinge element 8 is provided at a rear portion 27 of cabin structure 20′, preferably an apron-like support element 27 that extends downwards from a rear end of roof 23 protruding back with respect to rear uprights 26.

Device 30′ can also comprise a partial base frame 25 configured to be arranged upon a free upper plane of a vehicle. Rear uprights 26 can be connected at their lower end portion on partial base frame 25, so that that respective housings 26′ have a closed lower end portion. A container 28 can be arranged on partial base frame 25 which can house a hydraulic control unit and further devices that are necessary for operating actuator means 55 of safety legs 51′,51″.

The foregoing description exemplary specific embodiments of the anti-rollover device according to the invention will so fully reveal the invention according to the conceptual point of view, so that others, by applying current knowledge, will be able to modify and/or adapt for various applications such embodiment without further research and without parting from the invention, and, accordingly, it is meant that such adaptations and modifications will have to be considered as equivalent to the specific embodiments. The means and the materials to realise the different functions described herein could have a different nature without, for this reason, departing from the field of the invention. It is to be understood that the phraseology or terminology that is employed herein is for the purpose of description and not of limitation.

1. An anti-rollover device (1,50,70,80,90) for a vehicle (10) having lateral sides (10′,10″), a longitudinal axis (15) and a longitudinal midplane (16), said anti-rollover device (1,50,70,80,90) comprising:
at least two safety legs (5,31′,31″,51′,51″) comprising a right safety leg (5, 31′, 51′) and a left safety leg (5, 31″, 51″), each arranged at a respective side (10′, 10″) of said vehicle (10),
each of said safety legs (5, 31′, 31″, 51′,51″) having a free end portion (3,59) and an articulated end portion (4,54′,54″,87′,87″) opposite to said free end portion (3,59),
wherein each of said safety legs (5,31′,31″ 51′,51″) is connected to said vehicle (10) through said articulated end portion (4,54′,54″,87′,87″),
wherein each of said safety legs (5,31′,31″,51′,51″) is movable between a rest position (R), with minimum encumbrance with respect to said vehicle, and a support safety position (S), in which said free end portion (3,59) is located at a safety distance (D) from a respective side of said vehicle (10) so as to stop the rollover of said vehicle by one of said safety legs (5,31′,31″,51′,51″),
an actuator (100;55,56,60,67) configured for causing each of said safety legs (5,31′,31″,51′,51″) to move from said rest position to said support safety position;
a sensor (110;91,92,94) for detecting a value of a quantity related to an early rollover condition of said vehicle (10), said sensor configured for producing a signal (110′;91′,92′,94′) responsive to said value;
an automatic control unit (120) configured for receiving said signal (110′) and for activating said actuator (100,55,56,60,67) according to said signal (110′), in such a way that, in said early rollover condition, said actuator (100) causes at least one of said safety legs (5,31′,31″,51′,51″) to move impulsively from said rest position (R) to said support safety position (S),
wherein said automatic control unit (120) comprises a logical unit (125) for carrying out a comparison of said signal (110′;91′,92′,94′) with a limit value of said quantity, beyond which an early rollover condition of said vehicle occurs, said automatic control unit (120) configured for triggering said actuator (100;55,56,67) when said logical unit (125) assesses said early rollover condition by said comparison.

2. The anti-rollover device (50,70,80) according to claim 1, wherein said articulated end portion (4,54′,54″) is pivotally connected to said vehicle (10) for carrying out a rotation with respect to said vehicle (10) by a rotatable mutual engagement member about a rotation axis (57′,57″), and
in said rest position, each of said safety legs (5,51′,51″) is arranged along said respective side (10′,10″) of said vehicle (10) with a rest inclination, in particular a zero inclination, with respect to said vertical direction (16) of said vehicle (10), and
in said support safety position, each of said safety legs (5,51′,51″) has a safety inclination (a) with respect to said longitudinal midplane (16) of said vehicle (10) outwards of said vehicle (10), in such a way that said free end portion (3,59) is located at said safety distance (D) from a respective side (10′, 10″) of said vehicle.

3. The anti-rollover device (50,80) according to claim 2, wherein said rotatable mutual engagement member (58,40) is configured to be arranged with said rotation axis (57′,57″) at an orientation angle (8) with respect to the direction of said longitudinal axis (15) of said vehicle (10).

4. The anti-rollover device (50,70) according to claim 2, wherein said rotatable mutual engagement member (58,40) is configured to be arranged at a position above a cabin structure (20) of said vehicle (10); or a position on said respective side (10′,10″) of said vehicle (10).

5. The anti-rollover device (2,80) according to claim 2, wherein said vehicle is a forklift having a lifting guide element (14) and wherein said rotatable mutual engagement member (58,40) is configured to be arranged on an upper portion of the lifting guide element (14).

6. The anti-rollover device (70) according to claim 4, wherein said position is on said respective side (10′,10″) of said vehicle, where said rotatable mutual engagement member (58,40) is configured to be arranged, is below a cabin structure (20) of said vehicle (10).

7. The anti-rollover device (30,50,70,80) according to claim 2, wherein each of said safety legs (5,51′,51″) comprises an upper portion (52) and a lower portion (53) configured for slideably engaging with said upper portion (52) along a common longitudinal direction, in particular said lower portion (53) having a lower end (59) that, in said rest configuration (R), is arranged above a wheel housing (19′) of said vehicle (10).

8. The anti-rollover device (30,50,70,80) according to claim 7, wherein said upper portion (52) has a longitudinal recess, and said lower portion (53) is slideably arranged within said longitudinal recess of said upper portion (52).

9. The anti-rollover device (30,50,70,80) according to claim 7, comprising a slide actuator or a slide unlock mechanism of said lower portion (53) with respect to said upper portion (52), and said automatic control unit (120) is configured for operating said slide actuator or said slide unlock mechanism along with said actuator (55,56,67) of said rotation, so that said free end portion (3,59) comes into contact with the ground (18) in a predetermined position with respect to said vehicle (10).

10. The anti-rollover device (1,90) according to claim 1, wherein said articulated end portion is slideably connected to said vehicle (10) through a slidable mutual engagement member.

11. The anti-rollover device (90) according to claim 10, wherein said slidable mutual engagement member has a slide direction (47′,47″) at an operation angle (γ) with respect to said longitudinal midplane (16) of said vehicle (10) outwards of said vehicle (10).

12. The anti-rollover device (1,2,30,50,70,80,90) according to claim 1, wherein said safety leg (5,31′,31″,51′,51″) is arranged in such a way that said safety distance is longer than 0.5 m.

13. The anti-rollover device (1,2,30,50,70,80,90) according to claim 1, wherein said safety leg (5,31 ‘,31 “,51’,51”) is arranged in such a way that said safety distance is longer than 1 m.

14. The anti-rollover device (1,2,30,50,70,80,90) according to claim 1, wherein said actuator (100) is selected from the group consisting of:
a hydraulic actuator (55); a pneumatic actuator (55); an electromechanical actuator (35,56); and a mechanical actuator (60) comprising an actuation spring (60),
wherein said anti-rollover device (50) comprises a removable lock mechanism (67,68,69) for locking said safety legs (2,31′,31″,51′,51″) at said rest position, in which said actuation spring (60) is arranged to be kept stretched or compressed when a respective safety leg (5,31′,31″,51′,51″) is arranged in said rest position, and for recalling said respective safety leg (5,31′,31″,51′,51″) from said rest position to said support safety position when said removable lock mechanism (67) is removed.

15. The anti-rollover device (1,5,30,50,70,80,90) according to claim 1, wherein said sensor (110) for detecting values of a quantity related to an early rollover condition of said vehicle (10) is selected from the group consisting of:
an accelerometer (91) configured for measuring a lateral acceleration component of said vehicle (10), and for producing an electric lateral acceleration signal (91′) responsive to said acceleration component; a gyroscopic sensor (92) for measuring a spatial orientation of said vehicle (10), and configured for producing an electric orientation signal (92′) of said vehicle (10); an inclinometer (94) configured for measuring a lateral inclination of said vehicle (10), and for producing an electric lateral inclination signal (94′) of the vehicle responsive to said lateral inclination; and a combination thereof (91,92,94) for determining said early rollover condition.

16. The anti-rollover device (1,2,30,50,70,80,90) according to claim 1, wherein said logical unit (125) comprises:
a data input device (93), for inputting data of:
weight and volume of said vehicle (10);
weight and volume of a load (17) arranged on board of said vehicle (10);
a computing device for computing the position of the barycentre of a group comprising said vehicle (10) and said load (17) arranged on said vehicle (10), starting from said weight and volume data;
and said logical unit (125) is configured for combining said position of the barycentre and said electric lateral acceleration signal (91′) before carrying out said comparison.

17. The anti-rollover device (1,2,30,50,70,80,90) according to claim 1, wherein said input device comprises an input device for inputting elevation data of said load with respect to a reference plane.

18. The anti-rollover device according to claim 1, comprising a means (93) for computing the barycentre of a group consisting of said vehicle (10), of a load (17) arranged on said vehicle and of a driver of said vehicle (10), said means (93) for computing the barycentre is configured for determining a distance of said barycentre from said longitudinal midplane (16) of said vehicle (10).

19. The anti-rollover device according to claim 18, wherein said means (93) for computing the barycentre comprises a data acquisition unit (95) configured for receiving at least one of weight or volume data of said load (17), and said means (93) for computing the barycentre comprises a computing means (96) of said position of said barycentre, starting from data acquired from the data acquisition unit (95).

20. The anti-rollover device according to claim 19, wherein said data acquisition unit (95) is configured for receiving current elevation data of said load (17).

21. The anti-rollover device according to claim 19, wherein said data acquisition unit (95) is configured for receiving data selected from the group consisting of:
at least one of weight or volume data of said vehicle (10); and
at least one of weight or volume data of said driver (10).

22. The anti-rollover device according to claim 18, wherein said automatic control unit (120) is configured for receiving said position of said barycentre as calculated by said means (93) for computing the barycentre, and said automatic control unit (120) comprises a means (121) for combining said position of said barycentre with said measurement signal (110′) generated by said sensor (110).

23. The anti-rollover device according to claim 1, wherein said automatic control unit (120) is configured for receiving an auxiliary signal, and to emit said control signal (99) only if said auxiliary signal (98) exceeds a predetermined threshold value.

24. The device according to claim 23, comprising an auxiliary sensor (97) configured for measuring a quantity related to a ground contact condition (18) or to a ground no-contact condition (18) of at least one wheel (19) of said vehicle (10).

25. The device according to claim 24, wherein said auxiliary sensor (97) is
a distance sensor arranged for measuring a distance of a portion of said vehicle (10) from the ground (18); or
a force sensor arranged for measuring the weight borne by each of said wheels (19) of said vehicle (10), and wherein said automatic control unit (120) is configured for comparing said auxiliary signal with said threshold value.

26. (canceled)
